(19) United States
(12) Patent Application Publication
(10) Pub. No.: US 2025/0387764 A1
(43) Pub. Date: Dec. 25, 2025

(54) COAXIAL FLOW DEVICE FOR NANOPARTICLE PREPARATION AND MANUFACTURING EQUIPMENT INCLUDING SUCH DEVICE

(71) Applicant: Pfizer Inc., New York, NY (US)

(72) Inventors: Ramin Darvari, Lexington, MA (US); Mark Duda, Lynn, MA (US); Paul Francis Grden, Shrewsbury, MA (US); Arthur Louis Homer, Jr., Haverhill, MA (US); Jack Leonard Kibble, Cambridge (GB); Piet Josef Luc Renard, Puurs (BE); Can Sarisozen, Westford, MA (US)

(73) Assignee: Pfizer Inc., New York, NY (US)

(21) Appl. No.: 19/111,931

(22) PCT Filed: Sep. 12, 2023
(86) PCT No.: PCT/IB2023/059048

§ 371 Date: Mar. 14, 2025

Related U.S. Application Data
(60) Provisional application No. 63/406,892, filed on Sep. 15, 2022.

(51) Int. Cl. B01F 25/313; B01F 25/4314; B01F 25/441; B01F 25/442; B01F 25/452; B01F 101/22

(52) U.S. Cl. CPC B01F 25/3131; B01F 25/31324; B01F 25/31331; B01F 25/43141; B01F 25/4414; B01F 25/4421; B01F 25/45241; B01F 2101/22

(57) ABSTRACT

The invention relates to a coaxial flow device 1 capable of creating comparable microenvironments at various operation scales through the continuous introduction and mixing of nanoparticle precursor solutions for the manufacturing of a dispersion comprising nanoparticles. According to the invention, the device includes first and second coaxial tubes 3, 5 for controlled flows of nanoparticle precursor solutions and a mixing portion 7, wherein a disrupting physical element 21 is arranged to cause formation of the microenvironments. Application to the production of mRNA vaccines.

### TECHNICAL FIELD

The present invention relates to equipment and processes for the manufacturing of nanoparticles.

More specifically the invention relates to a coaxial flow device capable of creating comparable microenvironments at various operation scales through the continuous introduction and mixing of nanoparticle precursor solutions for the manufacturing of a dispersion comprising nanoparticles. The nanoparticles may optionally include an encapsulated payload.

### BACKGROUND OF THE INVENTION

In the pharmaceutical field, an increasing number of promising gene therapies and vaccines are based on RNA and DNA polymers. A critical issue associated with the implementation of such RNA- or DNA-based gene therapies or vaccines is delivery. Naked RNA or DNA molecules are rapidly degraded in biological fluids, do not accumulate in tissues following systemic administration, and cannot penetrate target cells, even if they get to the target tissues. Further, the immune system is designed to recognize and destroy vectors containing genetic information.

It has therefore been proposed to administer RNA or DNA molecules encapsulated in lipid nanoparticles (LNPs) such that the RNA or DNA molecules can be delivered to the target cells without degradation.

In the case of an RNA vaccine, LNPs aid delivery of RNA to cells and thereby promote an immunological response. The formation of the LNPs and the encapsulation of the RNA is critical to the efficacy of the vaccine and the manufacturing operations bringing the RNA and the lipid material together must be done in appropriate conditions to enable proper encapsulation.

Conventional in-line mixing devices, commercially available for the mixing of two pressurized or controlled fluid streams in a production line equipment in the pharmaceutical field, include so-called “tee mixer-type connectors”. The term “tee mixer-type connector” refers to a hydraulic connector designed to connect two tubes, possibly with different diameters, to combine fluid flows from these tubes and change their direction. It includes two opposing inlets oriented in substantially parallel directions and an outlet oriented in a substantially perpendicular direction. The inlets receive the flows from the two distinct tubes and these flows combine in the outlet. The two fluid flows from the connecting tubes may have different velocities. The term “tee mixer-type connector” encompasses such connectors forming a T shape (“T-mixer” or “T-connector”) and those forming a Y shape (“Y-mixer” or “Y-connector”).

Such mixing devices, while convenient for laboratory equipment or relatively small-scale production lines, cannot be adapted to high throughput and large scale production.

There is a requirement for production line equipment and more specifically for a mixing device to be able to combine two fluid streams, such as an RNA aqueous stream with one or more lipid organic stream(s), in a continuous and reproducible way, at various production scales. This is a particularly essential requirement for the production of vaccines in the context of a pandemic, wherein the vaccines need to be rapidly made available to the greatest number.

### SUMMARY OF THE INVENTION

According to a first aspect of the present invention, it is provided a coaxial flow device capable of creating comparable microenvironments at various operation scales through the continuous introduction and mixing of nanoparticle precursor solutions for the manufacturing of a dispersion comprising nanoparticles, the device including
a first tube having an inlet for a controlled flow of a first nanoparticle precursor solution,
at least a second tube, coaxially arranged within the first tube and having an inlet for a controlled flow of a second nanoparticle precursor solution, and
a mixing portion,
wherein
the first and second tubes have each an outlet which, in conjunction with fluid path elements, generate conditions for the continuous mixing of the nanoparticle precursor solutions and formation of nanoparticles,
and wherein
the fluid path elements include, arranged in the mixing portion, a disrupting physical element designed to cause formation of the microenvironments.

According to optional features, which may be considered separately or in every technically meaningful combination:
the disrupting physical element includes a helical groove along the longitudinal axis formed on the surface of one or both tubes, enabling scaling by controlling mixing within the microenvironment through changing flowrates, design, orientation and dimensions of both the pitch and depth of the grooves;
the disrupting physical element forms an annular outlet from the inner tube that generates the microenvironment, enabling scaling by controlling mixing within the microenvironment through changing the design, dimensions of the annular gap at the point of fluid introduction, flowrates and orientation of the obstruction;
the first and second tubes have a rectangular cross-section, with an aspect ratio unequal to one, over at least a portion extending from the respective outlet of the first and second tubes to a transition area between the microenvironment mixing portion and a physical disruption, enabling scaling by changing discharge dimensions, orientation, flowrates, and downstream placement of a disrupting physical element;
the helical groove has a constant pitch along the longitudinal axis;
the helical groove has a variable pitch along the longitudinal axis;
the disrupting physical element includes a packed bed of disrupting elements arranged within the mixing portion and defining therebetween interstitial spaces for the combined flow, enabling scaling by changing the design, flowrates, orientation, and dimensions of the bed packing elements, piping, and housing;
the disrupting physical element includes a coaxially positioned deflector at the outlet of the second tube and defining a gap therewith, said deflector being designed to outwardly deviate the flow from the second tube in an angled direction with respect to the longitudinal axis;
the device includes a set of further coaxial tubes arranged within the second tube, each further coaxial tube having an outlet and a corresponding coaxially positioned deflector part at the outlet thereof and defining a gap with the associated outer tube, said deflector part being designed to outwardly deviate the flow from the corresponding tube in an angled direction with respect to the longitudinal axis;
the disrupting physical element includes a longitudinal obturator obstructing the outlet of the second tube and circumferentially distributed radial openings formed in the second tube in the vicinity of the outlet thereof, whereby the flow from the second tube is radially deviated into the mixing portion.

In a further aspect of the invention, it is provided an equipment for the manufacturing of a dispersion comprising nanoparticles including an encapsulated payload, comprising
a coaxial flow device as depicted above,
a nanoparticle precursor solution connected to the inlet of the first, second, or more tube(s) of the device for the supply of nanoparticle precursor solution to said device, and
a payload solution connected to the inlet of the other tube of the device for the supply of payload solution to said device.

### BRIEF DESCRIPTION OF THE DRAWINGS

Preferred embodiments of the invention will now be described in more details, with reference to the following drawings wherein:

FIG. 1 is a schematic cross-sectional view, in an axial plane, of a coaxial flow device corresponding a first embodiment of the invention;

FIG. 2A is a schematic cross-sectional view, in an axial plane, of a coaxial flow device corresponding a second embodiment of the invention;

FIG. 2B and FIG. 2C are schematic cross-sectional views, respectively in plane B-B and plane C-C, of the coaxial flow device of FIG. 2A;

FIG. 3 is a schematic cross-sectional view, in an axial plane, of a coaxial flow device corresponding a third embodiment of the invention;

FIG. 4 is a schematic cross-sectional view, in an axial plane, of a coaxial flow device corresponding a fourth embodiment of the invention;

FIG. 5A is a schematic cross-sectional view, in an axial plane, of a coaxial flow device corresponding a fifth embodiment of the invention;

FIG. 5B is a schematic cross-sectional view, in plane B-B, of the coaxial flow device of FIG. 5A;

FIG. 6A is a schematic cross-sectional view, in an axial plane, of a coaxial flow device corresponding a sixth embodiment of the invention;

FIG. 6B is a schematic cross-sectional view, in plane B-B, of the coaxial flow device of FIG. 6A;

FIG. 7 is a schematic cross-sectional view, in an axial plane, of a coaxial flow device corresponding a seventh embodiment of the invention

### DETAILED DESCRIPTION OF PREFERRED EMBODIMENTS

### Definitions

The following definitions will be used in the present description and claims:
the term “laminar flow” refers to a flow wherein the Reynolds number is less than about 2,300;
the term “turbulent flow” refers to a flow wherein the Reynolds number is greater than about 4,000;
the term “transient flow” refers to a flow wherein the Reynolds number is between laminar and turbulent;
the term “microenvironments” means microscopic spaces formed as a result of combing two or more phases of nanoparticle precursor solutions within which the associated solutes precipitate to form nanostructure-containing dispersions;
unless stated otherwise, the terms “about” and “approximately” associated with a numeral value means within a range of ±5% of said value.

The invention will now be further illustrated by the following preferred embodiments, corresponding to a large scale coaxial flow mixing device and a manufacturing equipment including such a coaxial flow device that can be used for the commercial manufacturing of a formulation comprising lipid nanoparticles, optionally including a payload.

In particular, but not necessarily, the payload may be a polynucleotide. Also, the payload may include entities of one or more types.

In a particular application of the invention, the coaxial flow device may be used for the manufacturing of a formulation used in an mRNA vaccine.

Suitable lipids and polynucleotides for use with the coaxial flow device and manufacturing equipment of the invention are exemplified below.

### Lipids:

The lipid component of a LNP may include, for example, a cationic lipid, a phospholipid (such as an unsaturated lipid, e.g., DOPE or DSPC), a PEG lipid, and a structural lipid. The elements of the lipid component may be provided in specific fractions.

In some examples, the LNP further comprises a phospholipid, a PEG lipid, a structural lipid, or any combination thereof. Suitable phospholipids, PEG lipids, and structural lipids are further disclosed herein.

In some examples, the lipid component of a LNP includes a cationic lipid, a phospholipid, a polymer-conjugated lipid (e.g. polyethylene glycol (PEG)) and a structural lipid. In certain examples, the lipid component of the lipid nanoparticle includes about 30 mol % to about 60 mol % cationic lipid, about 0 mol % to about 30 mol % phospholipid, about 18.5 mol % to about 48.5 mol % structural lipid, and about 0 mol % to about 10 mol % of PEG lipid, provided that the total mol % does not exceed 100%. In some examples, the lipid component of the lipid nanoparticle includes about 35 mol % to about 55 mol % compound of cationic lipid, about 5 mol % to about 25 mol % phospholipid, about 30 mol % to about 40 mol % structural lipid, and about 0 mol % to about 10 mol % of PEG lipid. In a particular example, the lipid component includes about 50 mol % said cationic lipid, about 10 mol % phospholipid, about 38.5 mol % structural lipid, and about 1.5 mol % of PEG lipid. In another particular example, the lipid component includes about 40 mol % said cationic lipid, about 20 mol % phospholipid, about 38.5 mol % structural lipid, and about 1.5 mol % of PEG lipid. In some examples, the phospholipid may be DOPE or DSPC. In other examples, the PEG lipid may be PEG-DMG and/or the structural lipid may be cholesterol.

The amount of a therapeutic and/or prophylactic in a LNP may depend on the size, composition, desired target and/or application, or other properties of the lipid nanoparticle as well as on the properties of the therapeutic and/or prophylactic. For example, the amount of an RNA useful in a LNP may depend on the size, sequence, and other characteristics of the RNA. The relative amounts of a therapeutic and/or prophylactic and other elements (e.g., lipids) in a LNP may also vary. In some examples, the wt/wt ratio of the lipid component to a therapeutic and/or prophylactic in a LNP may be from about 5:1 to about 60:1, such as 5:1, 6:1, 7:1,8:1,9:1, 10:1, 11:1, 12:1, 13:1, 14:1, 15:1, 16:1, 17:1, 18:1, 19:1, 20:1, 25:1, 30:1, 35:1, 40:1, 45:1, 50:1, and 60:1. For example, the wt/wt ratio of the lipid component to a therapeutic and/or prophylactic may be from about 10:1 to about 40:1. In certain examples, the wt/wt ratio is about 20:1. The amount of a therapeutic and/or prophylactic in a LNP may, for example, be measured using absorption spectroscopy (e.g., ultraviolet-visible spectroscopy).

In some examples, the ionizable lipid is a compound of Formula (IL-I):

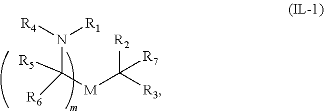

or their N-oxides, or salts or isomers thereof,
wherein:
Ri is selected from the group consisting of C5-30 alkyl, C5-20 alkenyl, —R*YR″, —YR″, and —R″M′R′; R2 and R3 are independently selected from the group consisting of H, C1-14 alkyl, C2-14 alkenyl, —R*YR″, —YR″, and —R*OR″, or R2 and R3, together with the atom to which they are attached, form a heterocycle or carbocycle; R4 is selected from the group consisting of hydrogen, a C3-6 carbocycle, —(CH2)nQ, —(CH2)nCHQR, —CHQR, —CQ(R)2, and unsubstituted C1-6 alkyl, where Q is selected from a carbocycle, heterocycle, —OR, -0(CH₂)nN(R)2, —C(0)OR, -0C(O)R, —CX3, —CX2H, —CXH2, —CN, —N(R)2, —C(0)N(R)2, —N(R)C(O)R, —N(R)S(0)₂R, —N(R)C(0)N(R)2, —N(R)C(S)N(R)2, —N(R)Re, N(R)S(0)₂R₈, -0(CH₂)nOR, —N(R)C(═NR9) N(R)2, —N(R)C(═CHR9)N(R)2, -0C(O)N(R)_{2J}—N(R)C(0)0R, —N(OR)C(O)R, —N(0R)S(0)2R, —N(OR)C(0)0R, —N(0R)C(0)N(R)2, —N(OR)C(S)N(R)2, —N(OR)C(═NR9)N(R)₂, —N(OR)C(═CHR9)N(R)2, —C(═NR9)N(R)₂, —C(═NR9)R, —C(0)N(R)0R, and —C(R)N(R)2C(0)0R, and each n is independently selected from 1, 2, 3, 4, and 5; each R5 is independently selected from the group consisting of C1-3 alkyl, C2-3 alkenyl, and H; each Re is independently selected from the group consisting of C1-3 alkyl, C2-3 alkenyl, and H; M and M′ are independently selected from —C(0)0-, —OC(O)—, -0C(0)-M″-C(0)0-, —C(0)N(R′)—, —N(R′)C(0)-, —C(O)—, —C(S)—, —C(S)S—, —SC(S)—, —CH(OH)—, —P(0)(0R′)0-, —S(0)₂-, —S—S—, an aryl group, and a heteroaryl group, in which M″ is a bond, C1-13 alkyl or C2-13 alkenyl; R7 is selected from the group consisting of C1-3 alkyl, C2-3 alkenyl, and H; Re is selected from the group consisting of C3-6 carbocycle and heterocycle; R9 is selected from the group consisting of H, CN, NO2, Ci-6 alkyl, —OR, —S(0)2R, —S(0)₂N(R)₂, C2-6 alkenyl, C3-6 carbocycle and heterocycle; each R is independently selected from the group consisting of C1-3 alkyl, C2-3 alkenyl, and H; each R′ is independently selected from the group consisting of Ci-is alkyl, C₂-is alkenyl, —R*YR″, —YR″, and H; each R″ is independently selected from the group consisting of C3-15 alkyl and C3-15 alkenyl; each R* is independently selected from the group consisting of Ci-i₂ alkyl and C₂₋ᵢ₂ alkenyl; each Y is independently a C3-6 carbocycle; each X is independently selected from the group consisting of F, Cl, Br, and I; and m is selected from 5, 6, 7, 8, 9, 10, 11, 12, and 13; and wherein when R₄ is —(CH₂)ₙQ, —(CH₂)nCHQR, —CHQR, or —CQ(R)₂, then (i) Q is not —N(R)₂ when n is 1, 2, 3, 4 or 5, or (ii) Q is not 5, 6, or 7-membered heterocycloalkyl when n is 1 or 2.

In preferred embodiments, the cationic lipid is a compound having the following structure (IE):

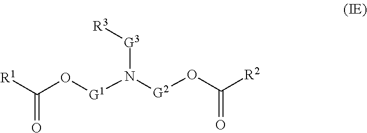

or a pharmaceutically acceptable salt or stereoisomer thereof, wherein:
G¹ and G² are each independently unsubstituted alkylene;
G³ is unsubstituted C1-C12 alkylene;
R¹ and R² are each independently C6-C24 alkyl;
R³ is OR⁵, CN, —C(═O)OR⁴, —OC(═O)R⁴ or NR⁵C(═O)R⁴;
R⁴ is C1-C12 alkyl; and
R⁵ is H or C1-C6 alkyl.

In some embodiments, the compound includes the following structure:

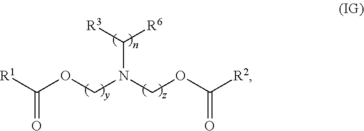

wherein R⁶ is, at each occurrence, H; n is an integer ranging from 2 to 12; and y and z are each independently integers ranging from 6 to 9. In some embodiments, n is 3, 4, 5 or 6. 4. In some embodiments, y and z are each 6. In some embodiments, y and z are each 9. In some embodiments, R¹ and R² each, independently has the following structure wherein: R^{7a} and R^{7b} are, at each occurrence, independently H or C1-C12 alkyl; and a is an integer from 2 to 12, wherein R^{7a}, R^{7b} and a are each selected such that R¹ and R² each independently comprise from 6 to 20 carbon atoms. In some embodiments, a is an integer from 8 to 12. In some embodiments, at least one occurrence of R^{7a} is H. In some embodiments, R^{7a} is H at each occurrence. In some embodiments, at least one occurrence of R^{7b} is C1-C8 alkyl. In some embodiments, C1-C8 alkyl is methyl, ethyl, n-propyl, iso-propyl, n-butyl, iso-butyl, tert-butyl, n-hexyl or n-octyl. In some embodiments, R³ is OH. In some embodiments, R³ is CN. In some embodiments, R³ is —C(═O)OR4, —OC(═O)R⁴ or NHC(═O)R⁴. In some embodiments, R⁴ is methyl or ethyl. In some embodiments, the compound has the following structure:

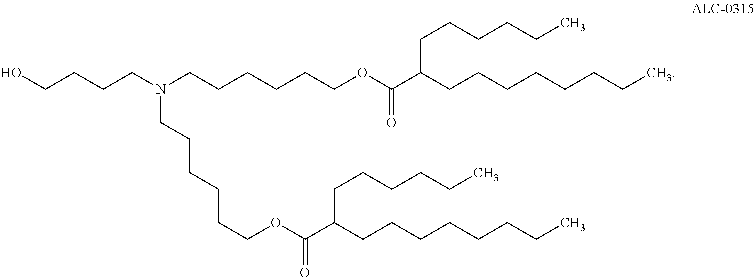 [SMILES: CCCCCCCCC(CCCCCC)C(=O)OCCCCCCN(CCCCO)CCCCCCOC(=O)C(CCCCCC)CCCCCCCC]

Additional exemplary ionizable lipids include:

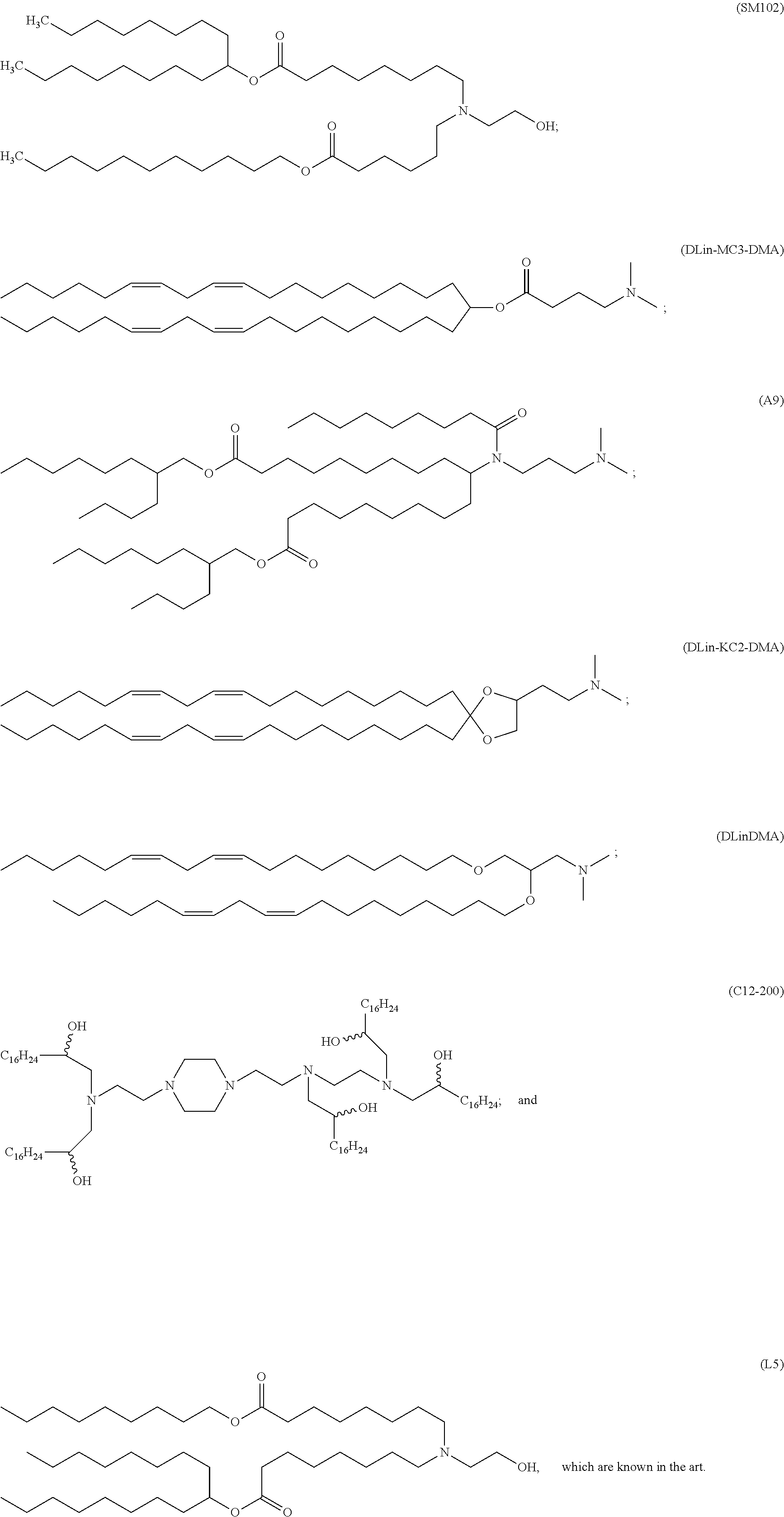

The lipid component of a lipid nanoparticle composition may include one or more molecules comprising polyethylene glycol, such as PEG or PEG-modified lipids. Such species may be alternately referred to as PEGylated lipids. A PEG lipid is a lipid modified with polyethylene glycol. A PEG lipid may be selected from the non-limiting group including PEG-modified phosphatidylethanolamines, PEG-modified phosphatidic acids, PEG-modified ceramides, PEG-modified dialkylamines, PEG-modified diacylglycerols, PEG-modified dialkylglycerols, and mixtures thereof. In some examples, a PEG lipid may be PEG-c-DOMG, PEG-DMG, PEG-DLPE, PEG-DMPE, PEG-DPPC, or a PEG-DSPE lipid. As used herein, the term “PEG lipid” refers to polyethylene glycol (PEG)-modified lipids. Non-limiting examples of PEG lipids include PEG-modified phosphatidylethanolamine and phosphatidic acid, PEG-ceramide conjugates (e.g., PEG-CerCl4 or PEG-CerC20), PEG-modified dialkylamines and PEG-modified 1,2-diacyloxypropan-3-amines. Such lipids are also referred to as PEGylated lipids. In some examples, a PEG lipid can be PEG-c-DOMG, PEG-DMG, PEG-DLPE, PEG-DMPE, PEG-DPPC, or a PEG-DSPE lipid. In some examples, the PEG-modified lipids are a modified form of PEG DMG. In some examples, the PEG-modified lipid is PEG lipid with the formula (IV):

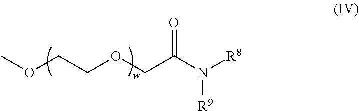

wherein R⁸ and R⁹ are each independently a straight or branched, saturated or unsaturated alkyl chain containing from 10 to 30 carbon atoms, wherein the alkyl chain is optionally interrupted by one or more ester bonds; and w has a mean value ranging from 30 to 60.

In some embodiments, the polymer-conjugated lipid is a polyoxazoline (POZ) lipid comprising the formula (IV):

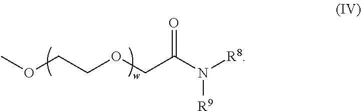

POZ is known in the art and is described in WO/2020/264505, PCT/US2020/040140, filed on Jun. 29, 2020.

In some embodiments, the PEGylated lipid has the following structure (II):

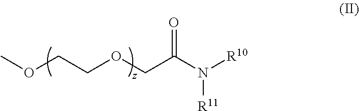

or a pharmaceutically acceptable salt, tautomer or stereoisomer thereof, wherein: R¹⁰ and R¹¹ are each independently a straight or branched, saturated or unsaturated alkyl chain containing from 10 to 30 carbon atoms, wherein the alkyl chain is optionally interrupted by one or more ester bonds; and z has a mean value ranging from 30 to 60; provided that R¹⁰ and R¹¹ are not both n-octadecyl when z is 42. In some embodiments of the PEGylated lipid, R¹⁰ and R¹¹ are each independently straight, saturated alkyl chains containing from 12 to 16 carbon atoms. In some embodiments, of the pegylated lipid z is about 45.

In some embodiments, the PEGylated lipid has one of the following structures:

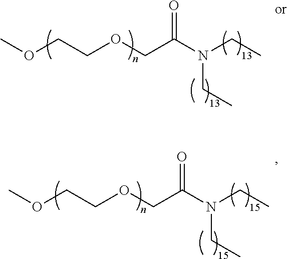

wherein n has a mean value ranging from 40 to 50. In a preferred embodiment, the composition comprises the ALC-315 cationic lipid described above and a PEGylated lipid having one of the following structures:

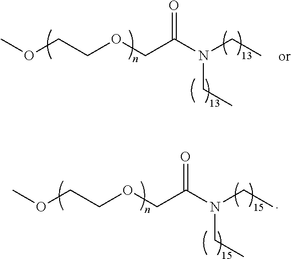

In some embodiments of the PEGylated lipid described above, R¹⁰ and R¹¹ are each independently a straight or branched, saturated or unsaturated alkyl chain containing 12 carbon atoms. In some embodiments of the PEGylated lipid described above, R¹⁰ and R¹¹ are each independently a straight or branched, saturated or unsaturated alkyl chain containing 14 carbon atoms. In some embodiments of the PEGylated lipid described above, R¹⁰ and R¹¹ are each independently a straight or branched, saturated or unsaturated alkyl chain containing 16 carbon atoms. Further exemplary lipids and related formulations thereof are disclosed for example, in U.S. Pat. No. 9,737,619, filed Feb. 14, 2017, U.S. Pat. No. 10,166,298, filed Oct. 28, 2016, and International Patent Application No. PCT/US2017/058619, filed Oct. 26, 2017, the disclosures of which are incorporated herein by reference in their entirety.

In some embodiments, the ionizable lipid is a compound of Formula (IL-I):

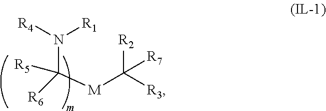

or their N-oxides, or salts or isomers thereof, wherein:
Rⁱ is selected from the group consisting of C₅₋₃₀ alkyl, C₅₋₂₀ alkenyl, —R*YR″, —YR″, and —R″M′R′; R² and R³ are independently selected from the group consisting of H, C₁₋₁₄ alkyl, C₂₋₁₄ alkenyl, —R*YR″, —YR″, and —R*OR″, or R² and R³, together with the atom to which they are attached, form a heterocycle or carbocycle; R⁴ is selected from the group consisting of hydrogen, a C₃₋₆ carbocycle, —(CH₂)nQ, —(CH₂)nCHQR, —CHQR, —CQ(R)₂, and unsubstituted C₁₋₆ alkyl, where Q is selected from a carbocycle, heterocycle, —OR, —O(CH₂)nN(R)₂, —C(O)OR, —OC(O)R, —CX₃, —CX₂H, —CXH₂, —CN, —N(R)₂, —C(O)N(R)₂, —N(R)C(O)R, —N(R)S(O)₂R, —N(R)C(O)N(R)₂, —N(R)C(S)N(R)₂, —N(R)Re, N(R)S(O)₂R₈, —O(CH₂)nOR, —N(R)C(═NR₉)N(R)₂, —N(R)C(═CHR₉)N(R)₂, —OC(O)N(R)₂J —N(R)C(O)OR, —N(OR)C(O)R, —N(OR)S(O)₂R, —N(OR)C(O)OR, —N(OR)C(O)N(R)₂, —N(OR)C(S)N(R)₂, —N(OR)C(═NR₉)N(R)₂, —N(OR)C(═CHR₉)N(R)₂, —C(═NR₉)N(R)₂, —C(═NR₉)R, —C(O)N(R)OR, and —C(R)N(R)₂C(O)OR, and each n is independently selected from 1, 2, 3, 4, and 5; each R⁵ is independently selected from the group consisting of C₁₋₃ alkyl, C₂₋₃ alkenyl, and H; each R^{e} is independently selected from the group consisting of C₁₋₃ alkyl, C₂₋₃ alkenyl, and H; M and M′ are independently selected from —C(O)O—, —OC(O)—, —OC(O)-M″-C(O)O—, —C(O)N(R′)—, —N(R′)C(O)—, —C(O)—, —C(S)—, —C(S)S—, —SC(S)—, —CH(OH)—, —P(O)(OR′)O—, —S(O)₂—, —S—S—, an aryl group, and a heteroaryl group, in which M″ is a bond, C₁₋₁₃ alkyl or C₂₋₁₃ alkenyl; R⁷ is selected from the group consisting of C₁₋₃ alkyl, C₂₋₃ alkenyl, and H; Re is selected from the group consisting of C₃₋₆ carbocycle and heterocycle; R⁹ is selected from the group consisting of H, CN, NO₂, C₁₋₆ alkyl, —OR, —S(O)₂R, —S(O)₂N(R)₂, C₂₋₆ alkenyl, C₃₋₆ carbocycle and heterocycle; each R is independently selected from the group consisting of C₁₋₃ alkyl, C₂₋₃ alkenyl, and H; each R′ is independently selected from the group consisting of C₁₋₁₅ alkyl, C₂₋₁₅ alkenyl, —R*YR″, —YR″, and H; each R″ is independently selected from the group consisting of C₃₋₁₅ alkyl and C₃₋₁₅ alkenyl; each R* is independently selected from the group consisting of C₁₋₁₂ alkyl and C₂₋₁₂ alkenyl; each Y is independently a C₃₋₆ carbocycle; each X is independently selected from the group consisting of F, Cl, Br, and I; and m is selected from 5, 6, 7, 8, 9, 10, 11, 12, and 13; and wherein when R⁴ is —(CH₂)nQ, —(CH₂)nCHQR, —CHQR, or —CQ(R)₂, then (i) Q is not —N(R)₂ when n is 1, 2, 3, 4 or 5, or (ii) Q is not 5, 6, or 7-membered heterocycloalkyl when n is 1 or 2.

### Polynucleotides and Nucleic Acids

In some examples, a LNP includes one or more polynucleotide or nucleic acid (e.g., ribonucleic acid or deoxyribonucleic acid). The term “polynucleotide,” in its broadest sense, includes any compound and/or substance that is or can be incorporated into an oligonucleotide chain. Exemplary polynucleotides for use in accordance with the present disclosure include, but are not limited to, one or more of deoxyribonucleic acid (DNA), ribonucleic acid (RNA) including messenger mRNA (mRNA), hybrids thereof, RNAi-inducing agents, RNAi agents, siRNAs, shRNAs, miRNAs, antisense RNAs, ribozymes, catalytic DNA, RNAs that induce triple helix formation, aptamers, vectors, etc. In some examples, a therapeutic and/or prophylactic is an RNA. RNAs useful in the compositions and methods described herein can be selected from the group consisting of, but are not limited to, shortmers, antagomirs, antisense, ribozymes, small interfering RNA (siRNA), asymmetrical interfering RNA (aiRNA), microRNA (miRNA), Dicer-substrate RNA (dsRNA), small hairpin RNA (shRNA), transfer RNA (tRNA), messenger RNA (mRNA), self-amplifying RNA (saRNA), and mixtures thereof. In certain examples, the RNA is an mRNA.

In certain examples, a therapeutic and/or prophylactic is an mRNA. An mRNA may encode any polypeptide of interest, including any naturally or non-naturally occurring or otherwise modified polypeptide. A polypeptide encoded by an mRNA may be of any size and may have any secondary structure or activity. In some examples, a polypeptide encoded by an mRNA may have a therapeutic effect when expressed in a cell.

In other examples, a therapeutic and/or prophylactic is an siRNA. An siRNA may be capable of selectively knocking down or down regulating expression of a gene of interest. For example, an siRNA could be selected to silence a gene associated with a particular disease, disorder, or condition upon administration to a subject in need thereof of a LNP including the siRNA. An siRNA may comprise a sequence that is complementary to an mRNA sequence that encodes a gene or protein of interest. In some examples, the siRNA may be an immunomodulatory siRNA.

In some examples, a therapeutic and/or prophylactic is an shRNA or a vector or plasmid encoding the same. An shRNA may be produced inside a target cell upon delivery of an appropriate construct to the nucleus. Constructs and mechanisms relating to shRNA are well known in the relevant arts.

Nucleic acids and polynucleotides useful in the disclosure typically include a first region of linked nucleosides encoding a polypeptide of interest (e.g., a coding region), a first flanking region located at the 5′-terminus of the first region (e.g., a 5-UTR), a second flanking region located at the 3′-terminus of the first region (e.g., a 3-UTR), at least one 5′-cap region, and a 3′-stabilizing region. In some examples, a nucleic acid or polynucleotide further includes a poly-A region or a Kozak sequence (e.g., in the 5′-UTR). In some cases, polynucleotides may contain one or more intronic nucleotide sequences capable of being excised from the polynucleotide. In some examples, a polynucleotide or nucleic acid (e.g., an mRNA) may include a 5′ cap structure, a chain terminating nucleotide, a stem loop, a poly A sequence, and/or a polyadenylation signal. Any one of the regions of a nucleic acid may include one or more alternative components (e.g., an alternative nucleoside). For example, the 3′-stabilizing region may contain an alternative nucleoside such as an L-nucleoside, an inverted thymidine, or a 2′-0-methyl nucleoside and/or the coding region, 5′-UTR, 3′-UTR, or cap region may include an alternative nucleoside such as a 5-substituted uridine (e.g., 5-methoxyuridine), a 1-substituted pseudouridine (e.g., 1-methyl-pseudouridine), and/or a 5-substituted cytidine (e.g., 5-methyl-cytidine).

Generally, the shortest length of a polynucleotide can be the length of the polynucleotide sequence that is sufficient to encode for a dipeptide. In another example, the length of the polynucleotide sequence is sufficient to encode for a tripeptide. In another example, the length of the polynucleotide sequence is sufficient to encode for a tetrapeptide. In another example, the length of the polynucleotide sequence is sufficient to encode for a pentapeptide. In another example, the length of the polynucleotide sequence is sufficient to encode for a hexapeptide. In another example, the length of the polynucleotide sequence is sufficient to encode for a heptapeptide. In another example, the length of the polynucleotide sequence is sufficient to encode for an octapeptide. In another example, the length of the polynucleotide sequence is sufficient to encode for a nonapeptide. In another example, the length of the polynucleotide sequence is sufficient to encode for a decapeptide.

In some cases, a polynucleotide is greater than 30 nucleotides in length. In another example, the polynucleotide molecule is greater than 35 nucleotides in length. In another example, the length is at least 40 nucleotides. In another example, the length is at least 45 nucleotides. In another example, the length is at least 55 nucleotides. In another example, the length is at least 50 nucleotides. In another example, the length is at least 60 nucleotides. In another example, the length is at least 80 nucleotides. In another example, the length is at least 90 nucleotides. In another example, the length is at least 100 nucleotides. In another example, the length is at least 120 nucleotides. In another example, the length is at least 140 nucleotides. In another example, the length is at least 160 nucleotides. In another example, the length is at least 180 nucleotides. In another example, the length is at least 200 nucleotides. In another example, the length is at least 250 nucleotides. In another example, the length is at least 300 nucleotides. In another example, the length is at least 350 nucleotides. In another example, the length is at least 400 nucleotides. In another example, the length is at least 450 nucleotides. In another example, the length is at least 500 nucleotides. In another example, the length is at least 600 nucleotides. In another example, the length is at least 700 nucleotides. In another example, the length is at least 800 nucleotides. In another example, the length is at least 900 nucleotides. In another example, the length is at least 1000 nucleotides. In another example, the length is at least 1100 nucleotides. In another example, the length is at least 1200 nucleotides. In another example, the length is at least 1300 nucleotides. In another example, the length is at least 1400 nucleotides. In another example, the length is at least 1500 nucleotides. In another example, the length is at least 1600 nucleotides. In another example, the length is at least 1800 nucleotides. In another example, the length is at least 2000 nucleotides. In another example, the length is at least 2500 nucleotides. In another example, the length is at least 3000 nucleotides. In another example, the length is at least 4000 nucleotides. In another example, the length is at least 5000 nucleotides, or greater than 5000 nucleotides.

In some examples, a LNP includes one or more RNAs, and the one or more RNAs, lipids, and amounts thereof may be selected to provide a specific N:P ratio. The N:P ratio of the composition refers to the molar ratio of nitrogen atoms in one or more lipids to the number of phosphate groups in an RNA. In general, a lower N:P ratio is preferred. The one or more RNA, lipids, and amounts thereof may be selected to provide an N:P ratio from about 2:1 to about 30:1, such as 2:1, 3:1, 4:1, 5:1, 6:1, 7:1, 8:1, 9:1, 10:1, 12:1, 14:1, 16:1, 18:1, 20:1, 22:1, 24:1, 26:1, 28:1, or 30:1. In certain examples, the N:P ratio may be from about 2:1 to about 8:1. In other examples, the N:P ratio is from about 5:1 to about 8:1. For example, the N:P ratio may be about 5.0:1, about 5.5:1, about 5.67:1, about 6.0:1, about 6.5:1, or about 7.0:1. For example, the N:P ratio may be about 5.67:1.

Nucleic acids and polynucleotides may include one or more naturally occurring components, including any of the canonical nucleotides A (adenosine), G (guanosine), C (cytosine), U (uridine), or T (thymidine). In one example, all or substantially all of the nucleotides comprising (a) 5′-UTR, (b) the open reading frame (ORF), (c) the 3′-UTR, (d) the poly A tail, and any combination of (a, b, c, or d above) comprise naturally occurring canonical nucleotides A (adenosine), G (guanosine), C (cytosine), U (uridine), or T (thymidine).

Nucleic acids and polynucleotides may include one or more alternative components, as described herein, which impart useful properties including increased stability and/or the lack of a substantial induction of the innate immune response of a cell into which the polynucleotide is introduced. For example, an alternative polynucleotide or nucleic acid exhibits reduced degradation in a cell into which the polynucleotide or nucleic acid is introduced, relative to a corresponding unaltered polynucleotide or nucleic acid. These alternative species may enhance the efficiency of protein production, intracellular retention of the polynucleotides, and/or viability of contacted cells, as well as possess reduced immunogenicity.

Polynucleotides and nucleic acids may be naturally or non-naturally occurring.

Polynucleotides and nucleic acids may include one or more modified (e.g., altered or alternative) nucleobases, nucleosides, nucleotides, or combinations thereof. The nucleic acids and polynucleotides useful in a LNP can include any useful modification or alteration, such as to the nucleobase, the sugar, or the internucleoside linkage (e.g., to a linking phosphate/to a phosphodiester linkage/to the phosphodiester backbone). In certain examples, alterations (e.g., one or more alterations) are present in each of the nucleobase, the sugar, and the internucleoside linkage. Alterations according to the present disclosure may be alterations of ribonucleic acids (RNAs) to deoxyribonucleic acids (DNAs), e.g., the substitution of the 2′-OH of the ribofuranosyl ring to 2′-H, threose nucleic acids (TNAs), glycol nucleic acids (GNAs), peptide nucleic acids (PNAs), locked nucleic acids (LNAs), or hybrids thereof. Additional alterations are described herein. Polynucleotides and nucleic acids may or may not be uniformly altered along the entire length of the molecule. For example, one or more or all types of nucleotide (e.g., purine or pyrimidine, or any one or more or all of A, G, U, C) may or may not be uniformly altered in a polynucleotide or nucleic acid, or in a given predetermined sequence region thereof. In some instances, all nucleotides X in a polynucleotide (or in a given sequence region thereof) are altered, wherein X may any one of nucleotides A, G, U, C, or any one of the combinations A+G, A+U, A+C, G+U, G+C, U+C, A+G+U, A+G+C, G+U+C or A+G+C.

Different sugar alterations and/or internucleoside linkages (e.g., backbone structures) may exist at various positions in a polynucleotide. One of ordinary skill in the art will appreciate that the nucleotide analogs or other alteration(s) may be located at any position(s) of a polynucleotide such that the function of the polynucleotide is not substantially decreased. An alteration may also be a 5′- or 3′-terminal alteration. In some examples, the polynucleotide includes an alteration at the 3′-terminus. The polynucleotide may contain from about 1% to about 100% alternative nucleotides (either in relation to overall nucleotide content, or in relation to one or more types of nucleotide, i.e., any one or more of A, G, U or C) or any intervening percentage (e.g., from 1% to 20%, from 1% to 25%, from 1% to 50%, from 1% to 60%, from 1% to 70%, from 1% to 80%, from 1% to 90%, from 1% to 95%, from 10% to 20%, from 10% to 25%, from 10% to 50%, from 10% to 60%, from 10% to 70%, from 10% to 80%, from 10% to 90%, from 10% to 95%, from 10% to 100%, from 20% to 25%, from 20% to 50%, from 20% to 60%, from 20% to 70%, from 20% to 80%, from 20% to 90%, from 20% to 95%, from 20% to 100%, from 50% to 60%, from 50% to 70%, from 50% to 80%, from 50% to 90%, from 50% to 95%, from 50% to 100%, from 70% to 80%, from 70% to 90%, from 70% to 95%, from 70% to 100%, from 80% to 90%, from 80% to 95%, from 80% to 100%, from 90% to 95%, from 90% to 100%, and from 95% to 100%). It will be understood that any remaining percentage is accounted for by the presence of a canonical nucleotide (e.g., A, G, U, or C).

Polynucleotides may contain at a minimum zero and at maximum 100% alternative nucleotides, or any intervening percentage, such as at least 5% alternative nucleotides, at least 10% alternative nucleotides, at least 25% alternative nucleotides, at least 50% alternative nucleotides, at least 80% alternative nucleotides, or at least 90% alternative nucleotides. For example, polynucleotides may contain an alternative pyrimidine such as an alternative uracil or cytosine. In some examples, at least 5%, at least 10%, at least 25%, at least 50%, at least 80%, at least 90% or 100% of the uracil in a polynucleotide is replaced with an alternative uracil (e.g., a 5-substituted uracil). The alternative uracil can be replaced by a compound having a single unique structure or can be replaced by a plurality of compounds having different structures (e.g., 2, 3, 4 or more unique structures). In some instances, at least 5%, at least 10%, at least 25%, at least 50%, at least 80%, at least 90% or 100% of the cytosine in the polynucleotide is replaced with an alternative cytosine (e.g., a 5-substituted cytosine). The alternative cytosine can be replaced by a compound having a single unique structure or can be replaced by a plurality of compounds having different structures (e.g., 2, 3, 4 or more unique structures).

In some instances, nucleic acids do not substantially induce an innate immune response of a cell into which the polynucleotide (e.g., mRNA) is introduced. Features of an induced innate immune response include 1) increased expression of pro-inflammatory cytokines, 2) activation of intracellular PRRs (RIG-I, MDA5, etc., and/or 3) termination or reduction in protein translation.

The nucleic acids can optionally include other agents (e.g., RNAi-inducing agents, RNAi agents, siRNAs, shRNAs, miRNAs, antisense RNAs, ribozymes, catalytic DNA, RNA, RNAs that induce triple helix formation, aptamers, vectors). In some examples, the nucleic acids may include one or more messenger RNAs (mRNAs) having one or more alternative nucleoside or nucleotides (i.e., alternative mRNA molecules).

The alternative nucleosides and nucleotides can include an alternative nucleobase. A nucleobase of a nucleic acid is an organic base such as a purine or pyrimidine or a derivative thereof. A nucleobase may be a canonical base (e.g., adenine, guanine, uracil, thymine, and cytosine). These nucleobases can be altered or wholly replaced to provide polynucleotide molecules having enhanced properties, e.g., increased stability such as resistance to nucleases. Non-canonical or modified bases may include, for example, one or more substitutions or modifications including but not limited to alkyl, aryl, halo, oxo, hydroxyl, alkyloxy, and/or thio substitutions; one or more fused or open rings; oxidation; and/or reduction.

Alternative nucleotide base pairing encompasses not only the standard adenine-thymine, adenine-uracil, or guanine-cytosine base pairs, but also base pairs formed between nucleotides and/or alternative nucleotides including non-standard or alternative bases, wherein the arrangement of hydrogen bond donors and hydrogen bond acceptors permits hydrogen bonding between a non-standard base and a standard base or between two complementary nonstandard base structures. One example of such non-standard base pairing is the base pairing between the alternative nucleotide inosine and adenine, cytosine, or uracil.

In some examples, the nucleobase is an alternative uracil. Exemplary nucleobases and nucleosides having an alternative uracil include pseudouridine (ψ), pyridin-4-one ribonucleoside, 5-aza-uracil, 6-aza-uracil, 2-thio-5-aza-uracil, 2-thio-uracil (s2U), 4-thio-uracil (s4U), 4-thio-pseudouridine, 2-thio-pseudouridine, 5-hydroxy-uracil (ho5U), 5-aminoallyl-uracil, 5-halo-uracil (e.g., 5-iodo-uracil or 5-bromo-uracil), 3-methyl-uracil (m U), 5-methoxy-uracil (mo5U), uracil 5-oxyacetic acid (cmo5U), uracil 5-oxyacetic acid methyl ester (mcmo5U), 5-carboxymethyl-uracil (cm5U), 1-carboxymethyl-pseudouridine, 5-carboxyhydroxymethyl-uracil (chm5U), 5-carboxyhydroxymethyl-uracil methyl ester (mchm5U), 5-methoxycarbonylmethyl-uracil (mcm5U), 5-methoxycarbonylmethyl-2-thio-uracil (mcm5s2U), 5-aminomethyl-2-thio-uracil (nmVu), 5-methylaminomethyl-uracil (mnm5U), 5-methylaminomethyl-2-thio-uracil (mnmVu), 5-methylaminomethyl-2-seleno-uracil (mnm5se2U), 5-carbamoylmethyl-uracil (ncm5U), 5-carboxymethylaminomethyl-uracil (cmnm5U), 5-carboxymethylaminomethyl-2-thio-uracil (cmnmVu), 5-propynyl-uracil, 1-propynyl-pseudouracil, 5-taurinomethyl-uracil (xm5U), 1-taurinomethyl-pseudouridine, 5-taurinomethyl-2-thio-uracil (xm5s2U), 1-taurinomethyl-4-thio-pseudouridine, 5-methyl-uracil (m5U, i.e., having the nucleobase deoxythymine), 1-methyl-pseudouridine (mV), 5-methyl-2-thio-uracil (m5s2U), I-methyl-4-thio-pseudouridine (m xj/), 4-thio-1-methyl-pseudouridine, 3-methyl-pseudouridine (m \/), 2-thio-1-methyl-pseudouridine, 1-methyl-1-deaza-pseudouridine, 2-thio-1-methyl-1-deaza-pseudouridine, dihydrouracil (D), dihydropseudouridine, 5,6-dihydrouracil, 5-methyl-dihydrouracil (m5D), 2-thio-dihydrouracil, 2-thio-dihydropseudouridine, 2-methoxy-uracil, 2-methoxy-4-thio-uracil, 4-methoxy-pseudouridine, 4-methoxy-2-thio-pseudouridine, N1-methyl-pseudouridine, 3-(3-amino-3-carboxypropyl) uracil (acp U), I-methyl-3-(3-amino-3-carboxypropyl) pseudouridine (acp ψ), 5-(isopentenylaminomethyl) uracil (inm5U), 5-(isopentenylaminomethyl)-2-thio-uracil (inm5s2U), 5,2′-0-dimethyl-uridine (m5Um), 2-thio-2′-0_methyl-uridine (s2Um), 5-methoxycarbonylmethyl-2′-0-methyl-uridine (mem Um), 5-carbamoylmethyl-2′-0-methyl-uridine (ncm5Um), 5-carboxymethylaminomethyl-2′-0-methyl-uridine (cmnm5Um), 3,2′-0-dimethyl-uridine (m Um), and 5-(isopentenylaminomethyl)-2′-0-methyl-uridine (inm5Um), 1-thio-uracil, deoxythymidine, 5-(2-carbomethoxyvinyl)-uracil, 5-(carbamoylhydroxymethyl)-uracil, 5-carbamoylmethyl-2-thio-uracil, 5-carboxymethyl-2-thio-uracil, 5-cyanomethyl-uracil, 5-methoxy-2-thio-uracil, and 5-[3-(I-E-propenylamino)]uracil.

In some examples, the nucleobase is an alternative cytosine. Exemplary nucleobases and nucleosides having an alternative cytosine include 5-aza-cytosine, 6-aza-cytosine, pseudoisocytidine, 3-methyl-cytosine (m3C), N4-acetyl-cytosine (ac4C), 5-formyl-cytosine (f5C), N4-methyl-cytosine (m4C), 5-methyl-cytosine (m5C), 5-halo-cytosine (e.g., 5-iodo-cytosine), 5-hydroxymethyl-cytosine (hm5C), 1-methyl-pseudoisocytidine, pyrrolo-cytosine, pyrrolo-pseudoisocytidine, 2-thio-cytosine (s2C), 2-thio-5-methyl-cytosine, 4-thio-pseudoisocytidine, 4-thio-1-methy 1-pseudoisocytidine, 4-thio-1-methyl-1-deaza-pseudoisocytidine, 1-methyl-1-deaza-pseudoisocytidine, zebularine, 5-aza-zebularine, 5-methy 1-zebularine, 5-aza-2-thio-zebularine, 2-thio-zebularine, 2-methoxy-cytosine, 2-methoxy-5-methyl-cytosine, 4-methoxy-pseudoisocytidine, 4-methoxy-1-methyl-pseudoisocytidine, lysidine (k2C), 5,2′-0-dimethyl-cytidine (m5Cm), N4-acetyl-2′-0-methyl-cytidine (ac4Cm), N4,2′-0-dimethyl-cytidine (m4Cm), 5-formyl-2′-0-methyl-cytidine (f5Cm), N4,N4,2′-0-trimethyl-cytidine (m42Cm), 1-thio-cytosine, 5-hydroxy-cytosine, 5-(3-azidopropyl)-cytosine, and 5-(2-azidoethyl)-cytosine.

In some examples, the nucleobase is an alternative adenine. Exemplary nucleobases and nucleosides having an alternative adenine include 2-amino-purine, 2,6-diaminopurine, 2-amino-6-halo-purine (e.g., 2-amino-6-chloro-purine), 6-halo-purine (e.g., 6-chloro-purine), 2-amino-6-methyl-purine, 8-azido-adenine, 7-deaza-adenine, 7-deaza-8-aza-adenine, 7-deaza-2-amino-purine, 7-deaza-8-aza-2-amino-purine, 7-deaza-2,6-diaminopurine, 7-deaza-8-aza-2,6-diaminopurine, 1-methy 1-adenine (mI A), 2-methyl-adenine (m2A), N6-methyl-adenine (m6A), 2-methylthio-N6-methyl-adenine (ms2m6A), N6-isopentenyl-adenine (i6A), 2-methylthio-N6-isopentenyl-adenine (ms2i6A), N6-(cis-hydroxyisopentenyl) adenine (io6A), 2-methylthio-N6-(cis-hydroxyisopentenyl) adenine (ms2i06A), N6-glycinylcarbamoyl-adenine (g6A), N6-threonylcarbamoyl-adenine (t6A), N6-methyl-N6-threonylcarbamoyl-adenine (m6t6A), 2-methylthio-N6-threonylcarbamoyl-adenine (ms2g6A), N6,N6-dimethyl-adenine (m62A), N6-hydroxynorvalylcarbamoyl-adenine (hn6A), 2-methylthio-N6-hydroxynorvalylcarbamoyl-adenine (ms2hn6A), N6-acetyl-adenine (ac6A), 7-methyl-adenine, 2-methylthio-adenine, 2-methoxy-adenine, N6,2′-0-dimethyl-adenosine (m6Am), N6,N6,2′-0-trimethyl-adenosine (m62Am), 1,2′-0-dimethyl-adenosine (m1 Am), 2-amino-N6-methyl-purine, 1-thio-adenine, 8-azido-adenine, N6-(19-amino-pentaoxanonadecyl)-adenine, 2,8-dimethyl-adenine, N6-formyl-adenine, and N6-hydroxymethyl-adenine.

In some examples, the nucleobase is an alternative guanine. Exemplary nucleobases and nucleosides having an alternative guanine include inosine (I), 1-methyl-inosine (mil), wyosine (imG), methylwyosine (mimG), 4-demethyl-wyosine (imG-14), isowyosine (imG2), wybutosine (yW), peroxywybutosine (o2yW), hydroxywybutosine (OHyW), undermodified hydroxywybutosine (OHyW*), 7-deaza-guanine, queuosine (Q), epoxyqueuosine (oQ), galactosyl-queuosine (galQ), mannosyl-queuosine (manQ), 7-cyano-7-deaza-guanine (preQO), 7-aminomethyl-7-deaza-guanine (preQI), archaeosine (G+), 7-deaza-8-aza-guanine, 6-thio-guanine, 6-thio-7-deaza-guanine, 6-thio-7-deaza-8-aza-guanine, 7-methyl-guanine (m7G), 6-thio-7-methyl-guanine, 7-methyl-inosine, 6-methoxy-guanine, 1-methyl-guanine (mIG), N2-methyl-guanine (m2G), N2,N2-dimethyl-guanine (m22G), N2,7-dimethyl-guanine (m2,7G), N2, N2,7-dimethyl-guanine (m2,2,7G), 8-oxo-guanine, 7-methyl-8-oxo-guanine, 1-methyl-6-thio-guanine, N2-methyl-6-thio-guanine, N2,N2-dimethyl-6-thio-guanine, N2-methyl-2′-0-methyl-guanosine (m2Gm), N2,N2-dimethyl-2′-0-methyl-guanosine (m22Gm), 1-methyl-2′-0-methyl-guanosine (mIGm), N2,7-dimethyl-2′-0-methyl-guanosine (m2,7Gm), 2′-0-methyl-inosine (Im), I,2′-0-dimethyl-inosine (mIIm), 1-thio-guanine, and O-6-methyl-guanine.

The alternative nucleobase of a nucleotide can be independently a purine, a pyrimidine, a purine or pyrimidine analog. For example, the nucleobase can be an alternative to adenine, cytosine, guanine, uracil, or hypoxanthine. In another example, the nucleobase can also include, for example, naturally-occurring and synthetic derivatives of a base, including pyrazolo[3,4-d]pyrimidines, 5-methylcytosine (5-me-C), 5-hydroxymethyl cytosine, xanthine, hypoxanthine, 2-aminoadenine, 6-methyl and other alkyl derivatives of adenine and guanine, 2-propyl and other alkyl derivatives of adenine and guanine, 2-thiouracil, 2-thiothymine and 2-thiocytosine, 5-propynyl uracil and cytosine, 6-azo uracil, cytosine and thymine, 5-uracil (pseudouracil), 4-thiouracil, 8-halo (e.g., 8-bromo), 8-amino, 8-thiol, 8-thioalkyl, 8-hydroxy and other 8-substituted adenines and guanines, 5-halo particularly 5-bromo, 5-trifluoromethyl and other 5-substituted uracils and cytosines, 7-methylguanine and 7-methyladenine, 8-azaguanine and 8-azaadenine, deazaguanine, 7-deazaguanine, 3-deazaguanine, deazaadenine, 7-deazaadenine, 3-deazaadenine, pyrazolo[3,4-d]pyrimidine, imidazo[I,5-a]1,3,5 triazinones, 9-deazapurines, imidazo[4,5-d]pyrazines, thiazolo[4,5-d]pyrimidines, pyrazin-2-ones, 1,2,4-triazine, pyridazine; or 1,3,5 triazine. When the nucleotides are depicted using the shorthand A, G, C, T or U, each letter refers to the representative base and/or derivatives thereof, e.g., A includes adenine or adenine analogs, e.g., 7-deaza adenine).

A polynucleotide (e.g., an mRNA) may include a 5′-cap structure. The 5′-cap structure of a polynucleotide is involved in nuclear export and increasing polynucleotide stability and binds the mRNA Cap Binding Protein (CBP), which is responsible for polynucleotide stability in the cell and translation competency through the association of CBP with poly-A binding protein to form the mature cyclic mRNA species. The cap further assists the removal of 5′-proximal introns removal during mRNA splicing. Endogenous polynucleotide molecules may be 5′-end capped generating a 5′-ppp-5′-triphosphate linkage between a terminal guanosine cap residue and 5′-terminal transcribed sense nucleotide of the polynucleotide. This 5′-guanylate cap may then be methylated to generate an N7-methyl-guanylate residue. The ribose sugars of the terminal and/or anteterminal transcribed nucleotides of 5′ end of the polynucleotide may optionally also be 2′-0-methylated. 5′-decapping through hydrolysis and cleavage of the guanylate cap structure may target a polynucleotide molecule, such as an mRNA molecule, for degradation.

Alterations to polynucleotides may generate a non-hydrolyzable cap structure preventing decapping and thus increasing polynucleotide half-life. Because cap structure hydrolysis requires cleavage of 5′-ppp-5′ phosphorodiester linkages, alternative nucleotides may be used during the capping reaction. For example, a Vaccinia Capping Enzyme from New England Biolabs (Ipswich, MA) may be used with a-thio-guanosine nucleotides according to the manufacturer's instructions to create a phosphorothioate linkage in the 5′-ppp-5′ cap.

Additional alternative guanosine nucleotides may be used such as α-methyl-phosphonate and seleno-phosphate nucleotides. Additional alterations include, but are not limited to, 2′-0-methylation of the ribose sugars of 5′-terminal and/or 5′-anteterminal nucleotides of the polynucleotide (as mentioned above) on the 2′-hydroxy group of the sugar. Multiple distinct 5′-cap structures can be used to generate the 5′-cap of a polynucleotide, such as an mRNA molecule.

Cap analogs, which herein are also referred to as synthetic cap analogs, chemical caps, chemical cap analogs, or structural or functional cap analogs, differ from natural (i.e., endogenous, wild-type, or physiological) 5′-caps in their chemical structure, while retaining cap function. Cap analogs may be chemically (i.e., non-enzymatically) or enzymatically synthesized and/linked to a polynucleotide. For example, the Anti-Reverse Cap Analog (ARCA) cap contains two guanosines linked by a 5′-5′-triphosphate group, wherein one guanosine contains an N7-methyl group as well as a 3′-0-methyl group (i.e., N7,3′-0-dimethyl-guanosine-5 ‘-triphosphate-5’-guanosine, m7G-3′mppp-G, which may equivalently be designated 3′ 0-Me-m7G(5′)ppp(5′)G). The 3′-0 atom of the other, unaltered, guanosine becomes linked to the 5′-terminal nucleotide of the capped polynucleotide (e.g., an mRNA). The N7- and 3′-0-methylated guanosine provides the terminal moiety of the capped polynucleotide (e.g., mRNA). Another exemplary cap is mCAP, which is similar to ARCA but has a 2′-0-methyl group on guanosine (i.e., N7,2′-0-dimethyl-guanosine-5′-triphosphate-5′-guanosine, m7Gm-ppp-G).

A cap may be a dinucleotide cap analog. As a non-limiting example, the dinucleotide cap analog may be modified at different phosphate positions with a boranophosphate group or a phophoroselenoate group such as the dinucleotide cap analogs described in U.S. Pat. No. 8,519,110, the cap structures of which are herein incorporated by reference.

Alternatively, a cap analog may be a N7-(4-chlorophenoxy ethyl) substituted dinucleotide cap analog known in the art and/or described herein. Non-limiting examples of N7-(4-chlorophenoxy ethyl) substituted dinucleotide cap analogs include a N7-(4-chlorophenoxyethyl)-G(5)ppp(5′)G and a N7-(4-chlorophenoxyethyl)-m3′-OG(5)ppp(5′)G cap analog (see, e.g., the various cap analogs and the methods of synthesizing cap analogs described in Kore et al. Bioorganic & Medicinal Chemistry 2013 21: 4570-4574; the cap structures of which are herein incorporated by reference). In other instances, a cap analog useful in the polynucleotides of the present disclosure is a 4-chloro/bromophenoxy ethyl analog.

While cap analogs allow for the concomitant capping of a polynucleotide in an in vitro transcription reaction, up to 20% of transcripts remain uncapped. This, as well as the structural differences of a cap analog from endogenous 5′-cap structures of polynucleotides produced by the endogenous, cellular transcription machinery, may lead to reduced translational competency and reduced cellular stability.

Alternative polynucleotides may also be capped post-transcriptionally, using enzymes, in order to generate more authentic 5′-cap structures. As used herein, the phrase “more authentic” refers to a feature that closely mirrors or mimics, either structurally or functionally, an endogenous or wild type feature. That is, a “more authentic” feature is better representative of an endogenous, wild-type, natural or physiological cellular function, and/or structure as compared to synthetic features or analogs of the prior art, or which outperforms the corresponding endogenous, wild-type, natural, or physiological feature in one or more respects. Non-limiting examples of more authentic 5′-cap structures useful in the polynucleotides of the present disclosure are those which, among other things, have enhanced binding of cap binding proteins, increased half-life, reduced susceptibility to 5′-endonucleases, and/or reduced 5′-decapping, as compared to synthetic 5′-cap structures known in the art (or to a wild-type, natural or physiological 5′-cap structure). For example, recombinant Vaccinia Virus Capping Enzyme and recombinant 2′-0-methyltransferase enzyme can create a canonical 5′-5′-triphosphate linkage between the 5′-terminal nucleotide of a polynucleotide and a guanosine cap nucleotide wherein the cap guanosine contains an N7-methylation and the 5′-terminal nucleotide of the polynucleotide contains a 2′-0-methyl. Such a structure is termed the CapI structure. This cap results in a higher translational-competency, cellular stability, and a reduced activation of cellular pro-inflammatory cytokines, as compared, e.g., to other 5′ cap analog structures known in the art. Other exemplary cap structures include 7mG(5′)ppp(5′)N,pN2p (Cap 0), 7mG(5′)ppp(5′)NImpNp (Cap 1), 7mG(5′)-ppp (5′)NImpN2mp (Cap 2), and m(7)Gpppm(3)(6,6,2′)Apm(2′)Apm(2′)Cpm(2)(3,2′)Up (Cap 4).

Because the alternative polynucleotides may be capped post-transcriptionally, and because this process is more efficient, nearly 100% of the alternative polynucleotides may be capped. This is in contrast to −80% when a cap analog is linked to a polynucleotide in the course of an in vitro transcription reaction. 5′-terminal caps may include endogenous caps or cap analogs. A 5′-terminal cap may include a guanosine analog. Useful guanosine analogs include inosine, NI-methyl-guanosine, 2′-fluoro-guanosine, 7-deaza-guanosine, 8-oxo-guanosine, 2-amino-guanosine, LNA-guanosine, and 2-azido-guanosine. In some cases, a polynucleotide contains a modified 5′-cap. A modification on the 5′-cap may increase the stability of polynucleotide, increase the half-life of the polynucleotide, and could increase the polynucleotide translational efficiency. The modified 5′-cap may include, but is not limited to, one or more of the following modifications: modification at the 2′- and/or 3′-position of a capped guanosine triphosphate (GTP), a replacement of the sugar ring oxygen (that produced the carbocyclic ring) with a methylene moiety (CH2), a modification at the triphosphate bridge moiety of the cap structure, or a modification at the nucleobase (G) moiety.

A 5′-UTR may be provided as a flanking region to polynucleotides (e.g., mRNAs). A 5-UTR may be homologous or heterologous to the coding region found in a polynucleotide. Multiple 5′-UTRs may be included in the flanking region and may be the same or of different sequences. Any portion of the flanking regions, including none, may be codon optimized and any may independently contain one or more different structural or chemical alterations, before and/or after codon optimization.

To alter one or more properties of a polynucleotide (e.g., mRNA), 5′-UTRs which are heterologous to the coding region of an alternative polynucleotide (e.g., mRNA) may be engineered. The polynucleotides (e.g., mRNA) may then be administered to cells, tissue or organisms and outcomes such as protein level, localization, and/or half-life may be measured to evaluate the beneficial effects the heterologous 5′-UTR may have on the alternative polynucleotides (mRNA). Variants of the 5′-UTRs may be utilized wherein one or more nucleotides are added or removed to the termini, including A, T, C or G. 5′-UTRs may also be codon-optimized, or altered in any manner described herein.

Polynucleotides (e.g., mRNAs) may include a stem loop such as, but not limited to, a histone stem loop. The stem loop may be a nucleotide sequence that is about 25 or about 26 nucleotides in length. The histone stem loop may be located 3′-relative to the coding region (e.g., at the 3′-terminus of the coding region). As a non-limiting example, the stem loop may be located at the 3′-end of a polynucleotide described herein. In some cases, a polynucleotide (e.g., an mRNA) includes more than one stem loop (e.g., two stem loops). A stem loop may be located in a second terminal region of a polynucleotide. As a non-limiting example, the stem loop may be located within an untranslated region (e.g., 3′-UTR) in a second terminal region. In some cases, a polynucleotide such as, but not limited to mRNA, which includes the histone stem loop may be stabilized by the addition of a 3′-stabilizing region (e.g., a 3′-stabilizing region including at least one chain terminating nucleoside). Not wishing to be bound by theory, the addition of at least one chain terminating nucleoside may slow the degradation of a polynucleotide and thus can increase the half-life of the polynucleotide. In other cases, a polynucleotide such as, but not limited to mRNA, which includes the histone stem loop may be stabilized by an alteration to the 3′-region of the polynucleotide that can prevent and/or inhibit the addition of oligio(U). In yet other cases, a polynucleotide such as, but not limited to mRNA, which includes the histone stem loop may be stabilized by the addition of an oligonucleotide that terminates in a 3′-deoxynucleoside, 2′,3′-dideoxynucleoside 3′-0-methylnucleosides, 3-0-ethylnucleosides, 3′-arabinosides, and other alternative nucleosides known in the art and/or described herein. In some instances, the polynucleotides of the present disclosure may include a histone stem loop, a poly-A region, and/or a 5′-cap structure. The histone stem loop may be before and/or after the poly-A region. The polynucleotides including the histone stem loop and a poly-A region sequence may include a chain terminating nucleoside described herein. In other instances, the polynucleotides of the present disclosure may include a histone stem loop and a 5′-cap structure. The 5′-cap structure may include, but is not limited to, those described herein and/or known in the art. In some cases, the conserved stem loop region may include a miR sequence described herein. As a non-limiting example, the stem loop region may include the seed sequence of a miR sequence described herein. In another non-limiting example, the stem loop region may include a miR-122 seed sequence.

Polynucleotides may include at least one histone stem-loop and a poly-A region or polyadenylation signal. In certain cases, the polynucleotide encoding for a histone stem loop and a poly-A region or a polyadenylation signal may code for a pathogen antigen or fragment thereof. In other cases, the polynucleotide encoding for a histone stem loop and a poly-A region or a polyadenylation signal may code for a therapeutic protein. In some cases, the polynucleotide encoding for a histone stem loop and a poly-A region or a polyadenylation signal may code for a tumor antigen or fragment thereof. In other cases, the polynucleotide encoding for a histone stem loop and a poly-A region or a polyadenylation signal may code for an allergenic antigen or an autoimmune self-antigen.

A polynucleotide or nucleic acid (e.g., an mRNA) may include a polyA sequence and/or polyadenylation signal. A polyA sequence may be comprised entirely or mostly of adenine nucleotides or analogs or derivatives thereof. A polyA sequence may be a tail located adjacent to a 3′ untranslated region of a nucleic acid. During RNA processing, a long chain of adenosine nucleotides (poly-A region) is normally added to messenger RNA (mRNA) molecules to increase the stability of the molecule. Immediately after transcription, 3′-end of the transcript is cleaved to free a 3′-hydroxy. Then poly-A polymerase adds a chain of adenosine nucleotides to the RNA. The process, called polyadenylation, adds a poly-A region that is between 100 and 250 residues long. Unique poly-A region lengths may provide certain advantages to the alternative polynucleotides of the present disclosure. Generally, the length of a poly-A region of the present disclosure is at least 30 nucleotides in length. In another example, the poly-A region is at least 35 nucleotides in length. In another example, the length is at least 40 nucleotides. In another example, the length is at least 45 nucleotides. In another example, the length is at least 55 nucleotides. In another example, the length is at least 60 nucleotides. In another example, the length is at least 70 nucleotides. In another example, the length is at least 80 nucleotides. In another example, the length is at least 90 nucleotides. In another example, the length is at least 100 nucleotides. In another example, the length is at least 120 nucleotides. In another example, the length is at least 140 nucleotides. In another example, the length is at least 160 nucleotides. In another example, the length is at least 180 nucleotides. In another example, the length is at least 200 nucleotides. In another example, the length is at least 250 nucleotides. In another example, the length is at least 300 nucleotides. In another example, the length is at least 350 nucleotides. In another example, the length is at least 400 nucleotides. In another example, the length is at least 450 nucleotides. In another example, the length is at least 500 nucleotides. In another example, the length is at least 600 nucleotides. In another example, the length is at least 700 nucleotides. In another example, the length is at least 800 nucleotides. In another example, the length is at least 900 nucleotides. In another example, the length is at least 1000 nucleotides. In another example, the length is at least 1100 nucleotides. In another example, the length is at least 1200 nucleotides. In another example, the length is at least 1300 nucleotides. In another example, the length is at least 1400 nucleotides. In another example, the length is at least 1500 nucleotides. In another example, the length is at least 1600 nucleotides. In another example, the length is at least 1700 nucleotides. In another example, the length is at least 1800 nucleotides. In another example, the length is at least 1900 nucleotides. In another example, the length is at least 2000 nucleotides. In another example, the length is at least 2500 nucleotides. In another example, the length is at least 3000 nucleotides. In some instances, the poly-A region may be 80 nucleotides, 120 nucleotides, 160 nucleotides in length on an alternative polynucleotide molecule described herein. In other instances, the poly-A region may be 20, 40, 80, 100, 120, 140 or 160 nucleotides in length on an alternative polynucleotide molecule described herein. In some cases, the poly-A region is designed relative to the length of the overall alternative polynucleotide. This design may be based on the length of the coding region of the alternative polynucleotide, the length of a particular feature or region of the alternative polynucleotide (such as mRNA) or based on the length of the ultimate product expressed from the alternative polynucleotide. When relative to any feature of the alternative polynucleotide (e.g., other than the mRNA portion which includes the poly-A region) the poly-A region may be 10, 20, 30, 40, 50, 60, 70, 80, 90 or 100% greater in length than the additional feature. The poly-A region may also be designed as a fraction of the alternative polynucleotide to which it belongs. In this context, the poly-A region may be 10, 20, 30, 40, 50, 60, 70, 80, or 90% or more of the total length of the construct or the total length of the construct minus the poly-A region.

In certain cases, engineered binding sites and/or the conjugation of polynucleotides (e.g., mRNA) for poly-A binding protein may be used to enhance expression. The engineered binding sites may be sensor sequences which can operate as binding sites for ligands of the local microenvironment of the polynucleotides (e.g., mRNA). As a non-limiting example, the polynucleotides (e.g., mRNA) may include at least one engineered binding site to alter the binding affinity of poly-A binding protein (PABP) and analogs thereof. The incorporation of at least one engineered binding site may increase the binding affinity of the PABP and analogs thereof.

Additionally, multiple distinct polynucleotides (e.g., mRNA) may be linked together to the PABP (poly-A binding protein) through 3′-end using alternative nucleotides at 3′-terminus of the poly-A region. Transfection experiments can be conducted in relevant cell lines at and protein production can be assayed by ELISA at 12 hours, 24 hours, 48 hours, 72 hours, and day 7 post-transfection. As a non-limiting example, the transfection experiments may be used to evaluate the effect on PABP or analogs thereof binding affinity as a result of the addition of at least one engineered binding site. In certain cases, a poly-A region may be used to modulate translation initiation. While not wishing to be bound by theory, the poly-A region recruits PABP which in turn can interact with translation initiation complex and thus may be essential for protein synthesis. In some cases, a poly-A region may also be used in the present disclosure to protect against 3′-5′-exonuclease digestion. In some instances, a polynucleotide (e.g., mRNA) may include a polyA-G Quartet. The G-quartet is a cyclic hydrogen bonded array of four guanosine nucleotides that can be formed by G-rich sequences in both DNA and RNA. In this example, the G-quartet is incorporated at the end of the poly-A region. The resultant polynucleotides (e.g., mRNA) may be assayed for stability, protein production and other parameters including half-life at various time points. It has been discovered that the polyA-G quartet results in protein production equivalent to at least 75% of that seen using a poly-A region of 120 nucleotides alone. In some cases, a polynucleotide (e.g., mRNA) may include a poly-A region and may be stabilized by the addition of a 3′-stabilizing region. The polynucleotides (e.g., mRNA) with a poly-A region may further include a 5′-cap structure. In other cases, a polynucleotide (e.g., mRNA) may include a poly-A-G Quartet. The polynucleotides (e.g., mRNA) with a poly-A-G Quartet may further include a 5′-cap structure. In some cases, the 3′-stabilizing region which may be used to stabilize a polynucleotide (e.g., mRNA) including a poly-A region or poly-A-G Quartet. In other cases, the 3′-stabilizing region which may be used with the present disclosure include a chain termination nucleoside such as 3′-deoxyadenosine (cordycepin), 3′-deoxyuridine, 3′-deoxycytosine, 3′-deoxyguanosine, 3′-deoxy thymine, 2′,3′-dideoxynucleosides, such as 2′,3′-dideoxyadenosine, 2′,3′-dideoxyuridine, 2′,3′-dideoxycytosine, 2′,3′-dideoxyguanosine, 2′,3′-dideoxythymine, a 2′-deoxynucleoside, or an O-methylnucleoside. In other cases, a polynucleotide such as, but not limited to mRNA, which includes a polyA region or a poly-A-G Quartet may be stabilized by an alteration to the 3′-region of the polynucleotide that can prevent and/or inhibit the addition of oligio(U). In yet other instances, a polynucleotide such as, but not limited to mRNA, which includes a poly-A region or a poly-A-G Quartet may be stabilized by the addition of an oligonucleotide that terminates in a 3′-deoxynucleoside, 2′,3′-dideoxynucleoside 3-0-methylnucleosides, 3′-0-ethylnucleosides, 3′-arabinosides, and other alternative nucleosides known in the art and/or described herein.

In some examples, the polynucleotide encodes an antigen derived from an infectious disease agent, such as a virus. In some embodiments, the polynucleotide comprises an influenza virus antigen. In some embodiments, the virus is a strain of Influenza A or Influenza B or combinations thereof. In some examples, the polynucleotide has an open reading frame encoding hemagglutinin (HA), or an immunogenic fragment or variant thereof.

In some embodiments, the antigen is influenza hemagglutinin 1 (HA1), hemagglutinin 2 (HA2), an immunogenic fragment of HA1 or HA2, or a combination of any two or more of the foregoing. In some embodiments, the RNA encodes at least two antigenic polypeptides or immunogenic fragments thereof, wherein a first antigen is HA1, HA2, or a combination of HA1 and HA2, and wherein a second antigen is neuraminidase (NA), nucleoprotein (NP), matrix protein 1 (M1), matrix protein 2 (M2), non-structural protein 1 (NS1) and non-structural protein 2 (NS2). In some embodiments, the RNA encodes at least two antigenic polypeptides or immunogenic fragments thereof, wherein a first antigen is HA1, HA2, or a combination of HA1 and HA2, and wherein a second antigen is neuraminidase (NA).

In some embodiments, the antigen is a polypeptide or an immunogenic fragment thereof from an arenavirus; an astrovirus; a bunyavirus; a calicivirus; a coronavirus; a filovirus; a flavivirus; a hepadnavirus; a hepevirus; an orthomyxovirus; a paramyxovirus; a picornavirus; a reovirus; a retrovirus; a rhabdovirus; a togavirus; or a combination of any two or more of the foregoing.

In some embodiments, the antigen is a polypeptide or an immunogenic fragment thereof from Acinetobacter baumannii, Anaplasma genus, Anaplasma phagocytophilum, Ancylostoma braziliense, Ancylostoma duodenale, Arcanobacterium haemolyticum, Ascaris lumbricoides, Aspergillus genus, Astroviridae, Babesia genus, Bacillus anthracis, Bacillus cereus, Bartonella henselae, BK virus, Blastocystis hominis, Blastomyces dermatitidis, Bordetella pertussis, Borrelia burgdorferi, Borrelia genus, Borrelia spp, Brucella genus, Brugia malayi, Bunyaviridae family, Burkholderia cepacia and other Burkholderia species, Burkholderia mallei, Burkholderia pseudomallei, Caliciviridae family, Campylobacter genus, Candida albicans, Candida spp, Chlamydia trachomatis, Chlamydophila pneumoniae, Chlamydophila psittaci, CJD prion, Clonorchis sinensis, Clostridium botulinum, Clostridium difficile, Clostridium perfringens, Clostridium perfringens, Clostridium spp, Clostridium tetani, Coccidioides spp, coronaviruses, Corynebacterium diphtheriae, Coxiella burnetii, Crimean-Congo hemorrhagic fever virus, Cryptococcus neoformans, Cryptosporidium genus, Cytomegalovirus (CMV), Dengue viruses (DEN-1, DEN-2, DEN-3 and DEN-4), Dientamoeba fragilis, Ebolavirus (EBOV), Echinococcus genus, Ehrlichia chaffeensis, Ehrlichia ewingii, Ehrlichia genus, Entamoeba histolytica, Enterococcus genus, Enterovirus genus, Enteroviruses, mainly Coxsackie A virus and Enterovirus 71 (EV71), Epidermophyton spp, Epstein-Barr Virus (EBV), Escherichia coli 01 57:H7, 01 1 1 and O104:H4, Fasciola hepatica and Fasciola gigantica, FFI prion, Filarioidea superfamily, Flaviviruses, Francisella tularensis, Fusobacterium genus, Geotrichum candidum, Giardia intestinalis, Gnathostoma spp, GSS prion, Guanarito virus, Haemophilus ducreyi, Haemophilus influenzae, Helicobacter pylori, Henipavirus (Hendra virus Nipah virus), Hepatitis A Virus, Hepatitis B Virus (HBV), Hepatitis C Virus (HCV), Hepatitis D Virus, Hepatitis E Virus, Herpes simplex virus 1 and 2 (HSV-1 and HSV-2), Histoplasma capsulatum, HIV (Human immunodeficiency virus), Hortaea werneckii, Human bocavirus (HBOV), Human herpesvirus 6 (HHV-6) and Human herpesvirus 7 (HHV-7), Human metapneumovirus (hMPV), Human papillomavirus (HPV), Human parainfluenza viruses (HPIV), Japanese encephalitis virus, JC virus, Junin virus, Kingella kingae, Klebsiella granulomatis, Kuru prion, Lassa virus, Legionella pneumophila, Leishmania genus, Leptospira genus, Listeria monocytogenes, Lymphocytic choriomeningitis virus (LCMV), Machupo virus, Malassezia spp, Marburg virus, Measles virus, Metagonimus yokagawai, Microsporidia phylum, Molluscum contagiosum virus (MCV), Mumps virus, Mycobacterium leprae and Mycobacterium lepromatosis, Mycobacterium tuberculosis, Mycobacterium ulcerans, Mycoplasma pneumoniae, Naegleria fowled, Necator americanus, Neisseria gonorrhoeae, Neisseria meningitidis, Nocardia asteroides, Nocardia spp, Onchocerca volvulus, Orientia tsutsugamushi, Orthomyxoviridae family (Influenza), Paracoccidioides brasiliensis, Paragonimus spp, Paragonimus westermani, Parvovirus B1 9, Pasteurella genus, Plasmodium genus, Pneumocystis jirovecii, Poliovirus, Rabies virus, Respiratory syncytial virus (RSV), Rhinovirus, rhinoviruses, Rickettsia akari, Rickettsia genus, Rickettsia prowazekii, Rickettsia rickettsii, Rickettsia typhi, Rift Valley fever virus, Rotavirus, Rubella virus, Sabia virus, Salmonella genus, Sarcoptes scabiei, SARS coronavirus, Schistosoma genus, Shigella genus, Sin Nombre virus, Hantavirus, Sporothrix schenckii, Staphylococcus genus, Staphylococcus genus, Streptococcus agalactiae, Streptococcus pneumoniae, Streptococcus pyogenes, Strongyloides stercoralis, Taenia genus, Taenia solium, Tick-borne encephalitis virus (TBEV), Toxocara canis or Toxocara cati, Toxoplasma gondii, Treponema pallidum, Trichinella spiralis, Trichomonas vaginalis, Trichophyton spp, Trichuris trichiura, Trypanosoma brucei, Trypanosoma cruzi, Ureaplasma urealyticum, Varicella zoster virus (VZV), Varicella zoster virus (VZV), Variola major or Variola minor, vCJD prion, Venezuelan equine encephalitis virus, Vibrio cholerae, West Nile virus, Western equine encephalitis virus, Wuchereria bancrofti, Yellow fever virus, Yersinia enterocolitica, Yersinia pestis, Yersinia pseudotuberculosis, or a combination of any two or more of the foregoing.

In some embodiments, the composition comprises a) at least one ribonucleic acid (RNA) polynucleotide having an open reading frame encoding influenza hemagglutinin 1 (HA1) or an immunogenic fragment thereof; b) at least one ribonucleic acid (RNA) polynucleotide having an open reading frame encoding hemagglutinin 2 (HA2) or an immunogenic fragment thereof; c) at least one ribonucleic acid (RNA) polynucleotide having an open reading frame encoding at least one antigenic polypeptide, wherein an antigen is neuraminidase (NA), nucleoprotein (NP), matrix protein 1 (M1), matrix protein 2 (M2), non-structural protein 1 (NS1) and non-structural protein 2 (NS2), or an immunogenic fragment thereof; and d) at least one ribonucleic acid (RNA) polynucleotide having an open reading frame encoding at least one antigenic polypeptide, wherein an antigen is neuraminidase (NA), nucleoprotein (NP), matrix protein 1 (M1), matrix protein 2 (M2), non-structural protein 1 (NS1) and non-structural protein 2 (NS2), or an immunogenic fragment thereof.

In some embodiments, provided polynucleotides (e.g., saRNA, mRNA) may be formulated with LNPs. In various embodiments, such LNPs can have an average size (e.g., mean diameter) equal to any one of, at least any one of, at most any one of, or between any two of about 30 nm to about 150 nm, about 40 nm to about 150 nm, about 50 nm to about 150 nm, about 50 nm to about 130 nm, about 50 nm to about 110 nm, about 50 nm to about 100 nm, about 50 to about 90 nm, or about 60 nm to about 80 nm, or about 60 nm to about 70 nm. In some embodiments, LNPs that may be useful in accordance with the present disclosure can have an average size (e.g., mean diameter) equal to any one of, at least any one of, at most any one of, or between any two of about 50 nm to about 100 nm. In some embodiments, LNPs may have an average size (e.g., mean diameter) of less than 80 nm, less than 75 nm, less than 70 nm, less than 65 nm, less than 60 nm, less than 55 nm, less than 50 nm, or less than 45 nm. In some embodiments, LNPs that may be useful in accordance with the present disclosure can have an average size (e.g., mean diameter) of equal to any one of, at least any one of, at most any one of, or between any two of about 45 nm, 50 nm, 55 nm, 60 nm, 65 nm, 70 nm, 75 nm, 80 nm, 85 nm, 90 nm, 95 nm, 100 nm, 105 nm, 110 nm, 115 nm, 120 nm, 125 nm, 130 nm, 135 nm, 140 nm, 145 nm, or 150 nm.

In certain embodiments, nucleic acids (e.g., RNAs), when present in provided LNPs, are resistant in aqueous solution to degradation with a nuclease. In some embodiments, LNPs are liver-targeting lipid nanoparticles. In some embodiments, LNPs are cationic lipid nanoparticles comprising one or more cationic lipids (e.g., ones described herein). In some embodiments, cationic LNPs may comprise at least one cationic lipid, at least one polymer conjugated lipid, and at least one helper lipid (e.g., at least one neutral lipid).

In some embodiments, LNP-encapsulated RNA can be produced by rapid mixing of an RNA solution described herein (e.g., the RNA product solution) and a lipid preparation described herein (comprising, e.g., at least one cationic lipid and optionally one or more other lipid components, in an organic solvent) under conditions such that a sudden change in solubility of lipid component(s) is triggered, which drives the lipids towards self-assembly in the form of LNPs. In some embodiments, suitable buffering agents comprise tris, histidine, citrate, acetate, phosphate, or succinate. The pH during preparation of a liquid LNP-encapsulated RNA formulation relates to the pKa of the encapsulating agent (e.g., cationic lipid). The pH of the acidifying buffer may be at least half a pH scale less than the pKa of the encapsulating agent (e.g., cationic lipid), and the pH of the final buffer may be at least half a pH scale greater than the pKa of the encapsulating agent (e.g., cationic lipid). In some embodiments, properties of a cationic lipid are chosen such that nascent formation of particles occurs by association with an oppositely charged backbone of a nucleic acid (e.g., RNA). In this way, particles are formed around the nucleic acid, which, for example, in some embodiments, can result in much higher encapsulation efficiency than it is achieved in the absence of interactions between nucleic acids and at least one of the lipid components. In some embodiments, the pH during preparation of LNP-encapsulated RNA is different from the pH of the LNP-encapsulated RNA post-preparation of the LNP-encapsulated RNA.

In one embodiment, the RNA in the RNA solution is at a concentration of <1 mg/mL. In another embodiment, the RNA is at a concentration of at least about 0.05 mg/mL. In another embodiment, the RNA is at a concentration of at least about 0.5 mg/mL. In another embodiment, the RNA is at a concentration of at least about 1 mg/mL. In another embodiment, the RNA concentration is from about 0.05 mg/mL to about 0.5 mg/mL. In another embodiment, the RNA is at a concentration of at least 10 mg/mL. In another embodiment, the RNA is at a concentration of at least 50 mg/mL. In some embodiments, the RNA is at a concentration of equal to any one of, at least any one of, at most any one of, or between any two of about 0.05 mg/mL, 0.5 mg/mL, 1 mg/mL, 10 mg/mL, 50 mg/mL, 75 mg/mL, 100 mg/mL, 150 mg/mL, 200 mg/mL, 250 mg/mL, 300 mg/mL, 400 mg/mL, or more.

In a further embodiment, the RNA solution and the lipid preparation mixture further comprises a stabilizing agent. In some embodiments, the stabilizing agent comprises sucrose, mannose, sorbitol, raffinose, trehalose, mannitol, inositol, sodium chloride, arginine, lactose, hydroxyethyl starch, dextran, polyvinylpyrolidone, glycine, or a combination thereof. In a specific embodiment, the stabilizing agent is sucrose. In a specific embodiment, the stabilizing agent is trehalose. In a specific embodiment, the stabilizing agent is a combination of sucrose and trehalose. In some embodiments, the stabilizing agent concentration includes, but is not limited to, a concentration of about 10 mg/mL to about 400 mg/mL, about 100 mg/mL to about 200 mg/mL, or about 103 mg/mL to about 200 mg/mL. In some embodiments, the concentration of the stabilizing agent is equal to any one of, at least any one of, at most any one of, or between any two of 10 mg/mL, 20 mg/mL, 50 mg/mL, 103 mg/mL, 150 mg/mL, 200 mg/mL, 300 mg/mL, 400 mg/mL, or more. In some embodiments, the concentration of the stabilizing agent(s) in the composition is about 1% to about 30% w/v. For example, the concentration of the stabilizing agent can be equal to any one of, at least any one of, at most any one of, or between any two of 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30% w/v. or any range or value derivable therein. In specific embodiments, the concentration of the stabilizing agent (e.g., sucrose) is 10.3%. In specific embodiments, the concentration of the stabilizing agent (e.g., sucrose) is 15.4%. In specific embodiments, the concentration of the stabilizing agent (e.g., sucrose) is 20.5%.

In a further embodiment, the mass amount of the stabilizing agent and the mass amount of the RNA are in a specific ratio. In one embodiment, the ratio of the mass amount of the stabilizing agent and the RNA is no greater than 5000. In another embodiment, the ratio of the mass amount of the stabilizing agent and the RNA is no greater than 2000. In another embodiment, the ratio of the mass amount of the stabilizing agent and the RNA is no greater than 1000. In another embodiment, the ratio of the mass amount of the stabilizing agent and the RNA is no greater than 500. In another embodiment, the ratio of the mass amount of the stabilizing agent and the RNA is no greater than 100. In another embodiment, the ratio of the mass amount of the stabilizing agent and the pharmaceutical substance is no greater than 50. In another embodiment, the ratio of the mass amount of the stabilizing agent and the RNA is no greater than 10. In another embodiment, the ratio of the mass amount of the stabilizing agent and the RNA is no greater than 1. In another embodiment, the ratio of the mass amount of the stabilizing agent and the RNA is no greater than 0.5. In another embodiment, the ratio of the mass amount of the stabilizing agent and the RNA is no greater than 0.1. In another embodiment, the stabilizing agent and RNA comprise a mass ratio of about 200-2000 of the stabilizing agent: 1 of the RNA. In a further embodiment, the RNA is saRNA and the stabilizing agent is sucrose.

In some embodiments, the RNA solution and the lipid preparation mixture further comprises a salt. In one embodiment, the salt is a sodium salt. In a specific embodiment, the salt is NaCl. In some embodiments, the RNA solution and the lipid preparation mixture further comprises a surfactant, a preservative, any other excipient, or a combination thereof. As used herein, “any other excipient” includes, but is not limited to, antioxidants, glutathione, EDTA, methionine, desferal, antioxidants, metal scavengers, or free radical scavengers. In one embodiment, the surfactant, preservative, excipient or combination thereof is selected from sterile water for injection (sWFI), bacteriostatic water for injection (BWFI), saline, dextrose solution, polysorbates, poloxamers, Triton, divalent cations, Ringer's lactate, amino acids, sugars, polyols, polymers or cyclodextrins.

The present disclosure relates to a coaxial flow device for a lipid nanoparticle (LNP) formulation and to a related manufacturing equipment, that combines lipid material and e.g. nucleic acid together in appropriate conditions to enable encapsulation.

### Embodiment 1

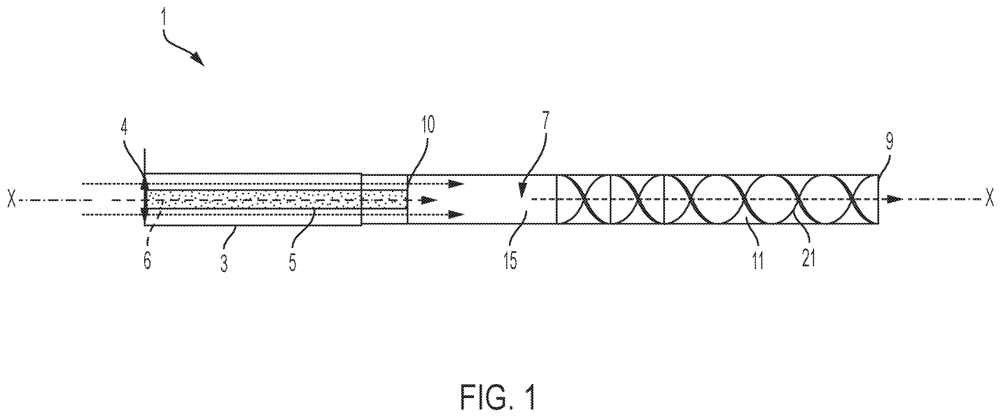

A first embodiment of the invention will now be described with reference to FIG. 1, which represents a coaxial flow device 1 for the continuous mixing of a lipid nanoparticle precursor solution and a payload (e.g. polynucleotide) solution for the manufacturing of a formulation comprising lipid nanoparticles encapsulating a payload, such as a polynucleotide payload.

The mixing device 1 is designed as a coaxial device extending along a main longitudinal axis X. It includes a first (outer) tube 3 having an inlet 4 for a controlled flow of one of the lipid nanoparticle precursor solution or the payload solution. It further includes a second (inner) tube 5 having an inlet 6 for a controlled flow of the other of the lipid nanoparticle precursor solution or the payload solution.

A lipid nanoparticle precursor solution container (not shown) is connected to the corresponding inlet of the mixing device 1 for the supply of lipid nanoparticle precursor solution. The flow of lipid nanoparticle precursor solution is controlled by a supply system (not shown).

Likewise, a payload (e.g. polynucleotide) solution container (not shown) is connected to the inlet of the other inlet of the mixing device 1 for the supply of payload solution, the flow of payload solution being controlled by a supply system (not shown).

The first tube 3 has a mixing portion 7 for the continuous mixing of the lipid nanoparticle precursor solution and the payload solution and an outlet 9 for a resulting flow of a mixed solution including the lipid nanoparticles encapsulating the payload.

The second tube 5 is coaxially arranged, along the longitudinal axis X, within the first tube 3 and has an outlet 10 axially opening into said mixing portion 7 of the first tube 3. In the present embodiment, the first 3 and second 5 tubes preferably have a circular cross-section and have a constant cross-section over their length.

The mixing portion 7 is designed for generating controlled micro-mixing environment and micro-environments in the resulting flow. It is also designed to further increase turbulent mixing of the lipid nanoparticle precursor solution and the payload solution. To that end, it includes a turbulent mixing portion 11 provided with a disrupting physical element designed to generate micro-environments and generate (or increase) turbulence in the combined flow of the lipid nanoparticle precursor solution and the payload solution.

The mixing portion 7 further includes, between the outlet 10 of the second tube 5 and the turbulent mixing portion 11, a controlled micro-mixing environment portion 15 free of obstacle for the combined flow. In the controlled micro-mixing environment portion 15, a superficial mixing is achieved at the interface of the lipid and payload streams.

The disrupting physical element extends over a certain length of the mixing portion 7, in this case in the turbulent mixing portion 11, from the downstream end of the controlled micro-mixing environment portion 15 to the outlet 9 of the first tube 3 and includes, more precisely in the present embodiment consists of, an alternating helical flow path 21 in the form of a helical groove, arranged on an inner surface of the first tube 3. The helical groove may be formed in the inner surface of the tube or formed as a separate part.

The proposed coaxial design enables adapting the mixing device to the desired production scale whilst maintaining mixing performance through optimizing various parameters such as the orientation, flowrates, dimensions of the tubes, mixing portion and downstream placement of the disrupting physical element.

### Embodiment 2

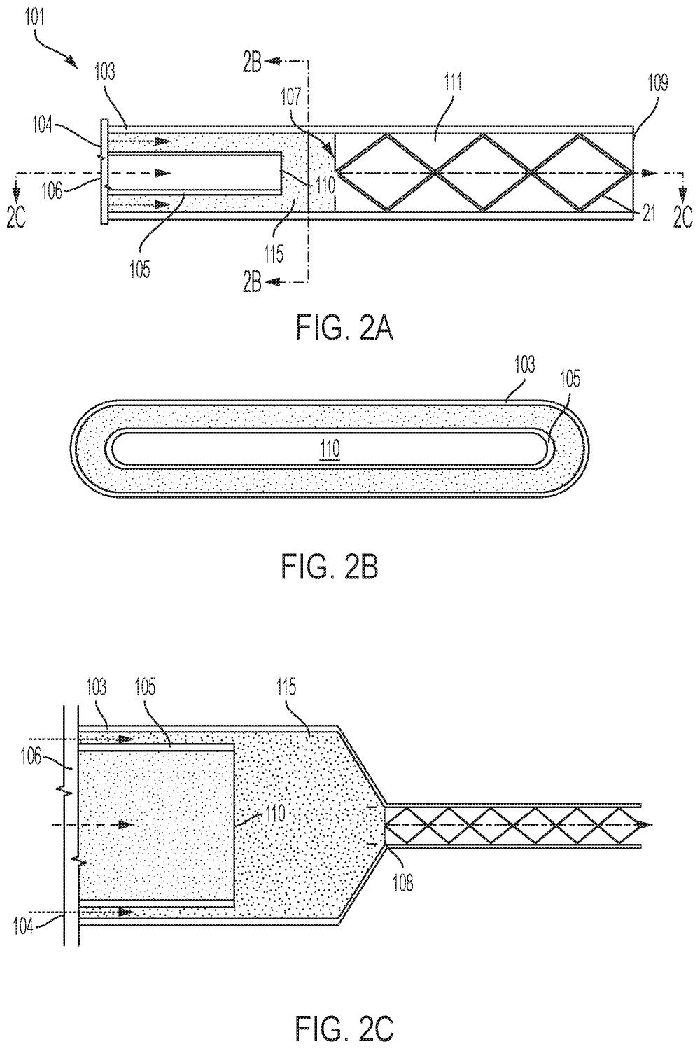

A second embodiment of the invention is illustrated on FIGS. 2A, 2B and 2C.

The mixing device 101 present embodiment mainly differs from the first embodiment in that the mixing portion 107 further includes a neck portion 108 between the controlled micro-mixing environment portion 115 (free of disrupting physical elements) and the turbulent mixing portion 111, whereby the controlled micro-mixing environment portion 115 have a greater flow cross-section than the turbulent mixing portion 111.

Also, as seen on FIG. 2B, the first 103 and second 105 tubes have a generally rectangular cross-section (with convex curved sides) over at least a portion of their length. Preferably, the first tube 103 has a generally rectangular cross-section over the portion extending from the respective inlet 104 the neck portion 108, the turbulent mixing portion 111 between the neck 108 and the outlet 109 being cylindrical with a circular cross-section. The second tube 105 preferably has a generally rectangular cross-section over its whole length, from the respective inlet 104 to the respective outlets 110.

The disrupting physical element in this embodiment is in essence identical to the one of the first embodiment, namely consisting of an alternating helical flow path 21 arranged on the inner surface of the first tube 103.

This embodiment is of particular interest for maintaining micro-environment mixing whilst increasing throughput.

### Embodiment 3

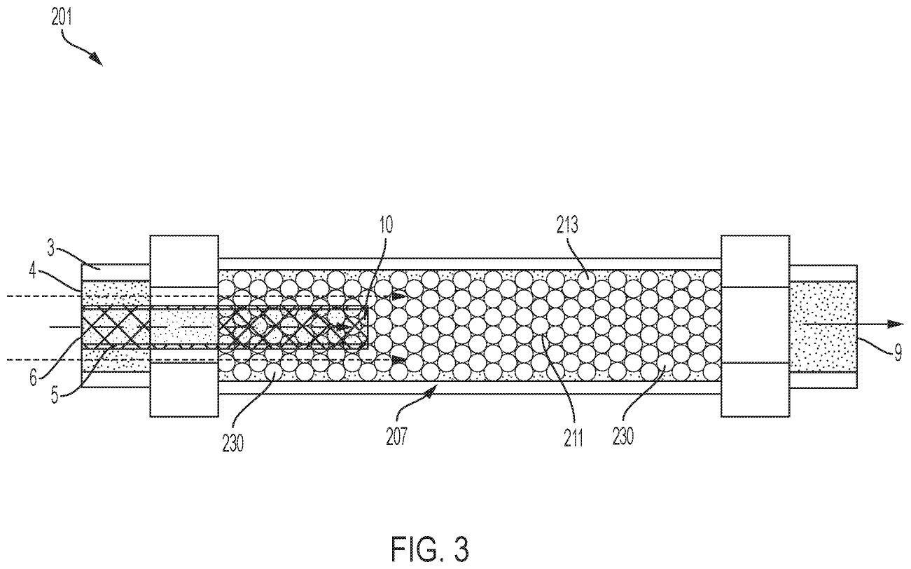

A third embodiment of the invention is illustrated on FIG. 3.

The mixing device 201 of the present embodiment mainly differs from the first embodiment in that the disrupting physical element 213 causing turbulence in the combined flow includes a packed bed of spheres 230 arranged within the mixing portion 207.

The spheres 230 define therebetween interstitial spaces for the combined flow. They are substantially non-deformable and non-porous and preferably made of a material such as stainless steel or pharmaceutically acceptable (and process-compatible) polymers, such as polypropylene and polyacetal. The diameter of the spheres may preferably be approximately between 1 and 5 mm, preferably between 2 and 4 mm. The diameter of the tubes 3, 5, dimensions of the spheres 230 and their arrangement within the mixing portion 207 may be optimized to provide the desired turbulent mixing effect, velocity of the combined stream and flowrate.

As can be seen on FIG. 3, spheres 230 may be provided not only in the mixing portion 207 for the combined stream, but also within the first tube 3 in a portion between the inlet 4 thereof and the outlet 10 of the second tube 5, whereby turbulence is generated in the stream of the solution supplied to the first tube 3 upstream to the mixing portion 207. Mixing of the two solutions may be enhanced by generating turbulence in at least one of the incoming streams to be combined.

It will be noted that, in the present embodiment, no portion free of physical obstacles is provided in the mixing portion 207 as spheres 230 are arranged at the outlet 10 of the second tube 5. However, it is conceivable that a space free of spheres and of any obstacle is provided in the mixing section at the outlet 10.

### Embodiment 4

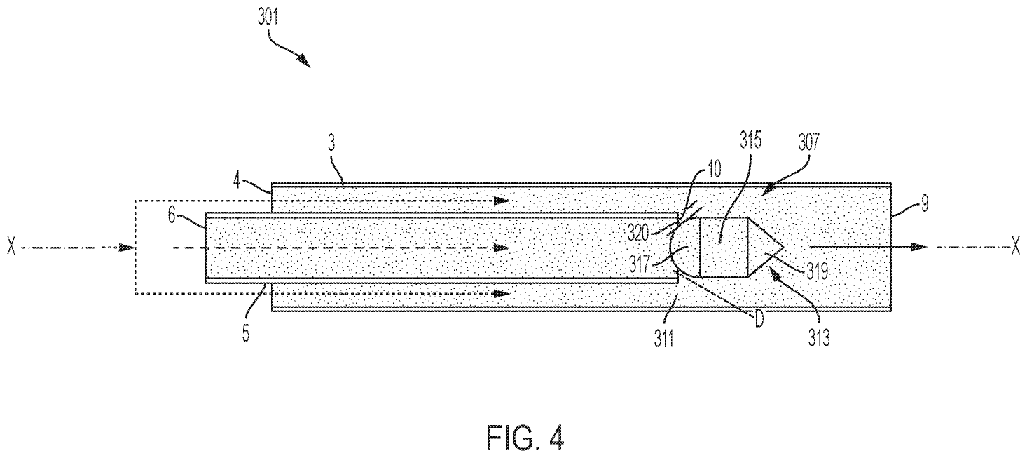

A fourth embodiment of the invention is illustrated on FIG. 4.

The mixing device 301 of the present embodiment mainly differs from the third embodiment in that the disrupting physical element 313 causing turbulence in the combined flow includes, more precisely in the represented embodiment consists of, a deflector coaxially arranged at the outlet 10 of the second tube 5.

The deflector 313 is designed as an integral part presenting a continuous external surface, having a central cylindrical portion 315 extending along the main longitudinal axis X, a conical portion 317 with its conical apex opposing the outlet 10, and a coaxial conical portion 319 with the apex thereof oriented in the downstream direction.

The deflector 313 and more specifically its portion 317 is slightly spaced from the outlet 10 of the second tube 5, thereby defining a gap 320 with the outlet 10. The deflector 313 is thus designed to outwardly deviate the flow from the second tube 5 in an angled direction D with respect to the longitudinal axis X.

The angled direction D is inclined by an angle between 30° and 60°, preferably between 40° and 50°, preferably equal to about 45°, with respect to the longitudinal axis X. The optimal angle value would depend upon the scale of the mixer.

### Embodiment 5

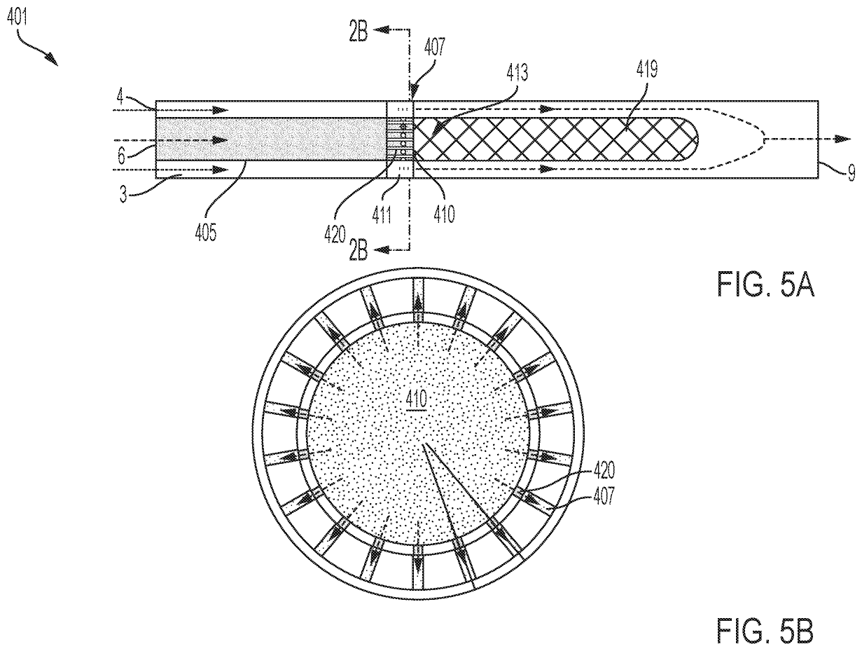

A fifth embodiment of the invention is illustrated on FIG. 5A, 5B.

The mixing device 401 of the present embodiment mainly differs from the fourth embodiment in that the disrupting physical element 413 includes, more precisely in the represented embodiment consists of, an obturator 419, as opposed to a deflector, axially obstructing the outlet 410 of the second tube 405 and circumferentially distributed radial openings 420 formed in the second tube 405. The openings 420 are formed in the vicinity of the outlet 410 and are separated by fins.

It will be appreciated that the flow from the second tube 405 is radially deviated through the openings 420 into the mixing portion 407.

### Embodiment 6

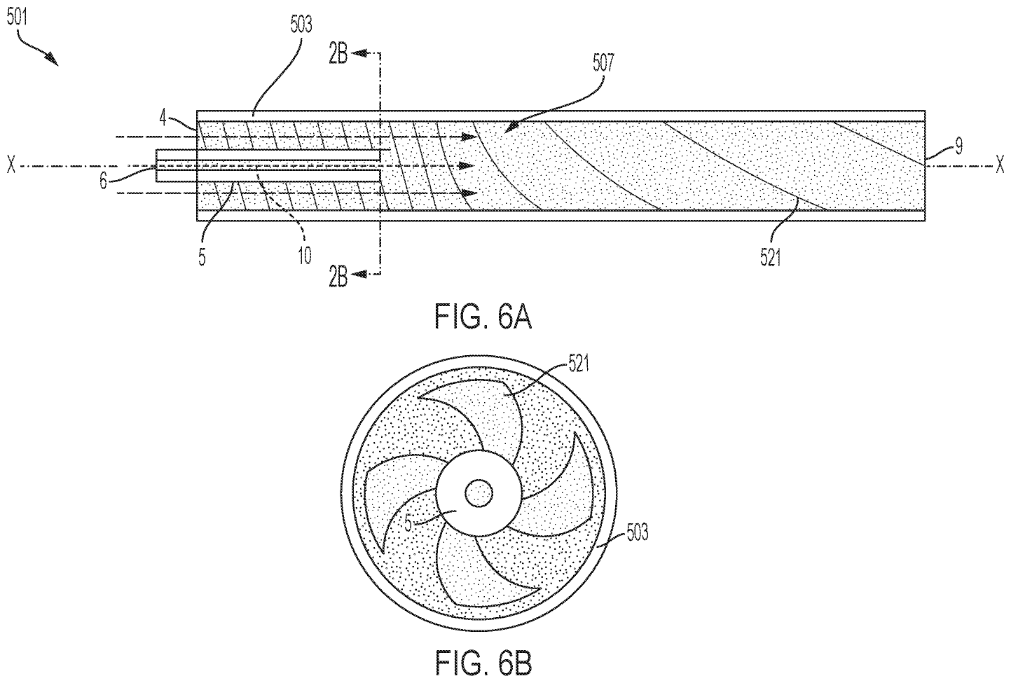

A sixth embodiment of the invention is illustrated on FIG. 6A, 6B.

In the mixing device 501 of the present embodiment, the disrupting physical element includes, a spiral groove 521 formed on the inner surface of the first tube 503, in particular of the mixing portion 507.

In the present embodiment, the spiral groove 521 has a variable pitch along the longitudinal axis X and in that no portion free of disrupting element is provided in the mixing portion 507, as the spiral groove 521 is formed over the whole length of the mixing portion 507 i.e. downstream to the outlet 10 of the second tube 5.

The variable pitch is an optional feature and a constant pitch may be preferred for certain operating conditions. The spiral groove, in this embodiment, is the key feature that imparts the required scalable micro-mixing environment.

While this feature is optional, the spiral groove (or rifling) 521 is formed not only in the mixing portion 507, but over the whole length of the first tube 503. Rifling over the entire tube 503 allows for conditioning the flow from inlet 4 before it meets with the flow from outlet 10. This is to help ensure the intended flow profile is achieved.

As particularly visible on FIG. 6B, the second (inner) tube 5 is coaxially centered within the first (outer) tube 503 by bearing on the innermost surfaces of the first tube 503 defined by the spiral groove 521.

### Embodiment 7

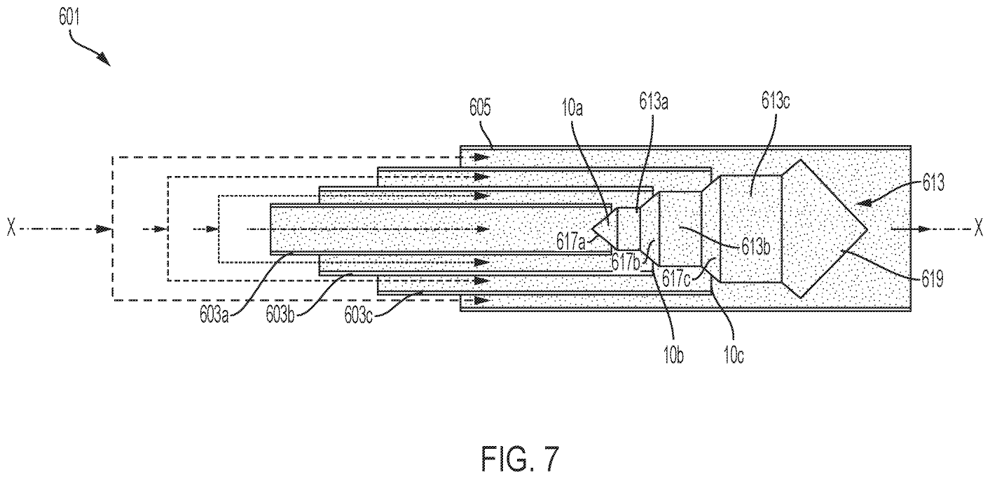

A seventh embodiment of the invention is illustrated on FIG. 7.

In this embodiment, the device 601 is adapted to mix multiple different solutions from multiple sources, four solutions in the represented example.

The device therefore includes a set of three coaxial inner tubes 603a, 603b, 603c, each being coaxially arranged within another, and an outer coaxial tube 605. The inner tubes 603a, 603b, 603c are arranged within the outer tube 605.

Similarly to the fourth embodiment, each inner coaxial tube 603a, 603b, 603c have an outlet 10a, 10b, 10c and a corresponding coaxially positioned deflector part 613a, 613b, 613c at the outlet thereof.

Each deflector part 613a, 613b, 613c has a continuous external surface, with a cylindrical portion extending along the main longitudinal axis X, a conical portion 617a, 617b, 617c opposing the respective outlet 10a, 10b, 10c.

The deflector parts 613a, 613b, 613c are made integral into a stepped deflector 613 that further has a downstream coaxial conical portion 619 with the apex thereof oriented in the downstream direction.

The portion 617a, 617b, 617c of each deflector part is slightly spaced from the respective outlet 10a, 10b, 10c, thereby defining a gap with the outlet 10. The deflector parts are thus designed to outwardly deviate the flow from the respective tubes in an angled direction with respect to the longitudinal axis X.

Still similarly to the fourth embodiment, the angled direction may be inclined by an angle between 30° and 60°, preferably between 40° and 50°, preferably equal to about 45°, with respect to the longitudinal axis X. The optimal angle value would depend upon the scale of the mixer.

The invention described in the foregoing is of particular interest for the manufacturing of an RNA vaccine, wherein the payload solution is an RNA solution, and still more particularly a mRNA solution for a mRNA vaccine production. The RNA may preferably be present in an aqueous phase prior to entering the mixing device.

1. A coaxial flow device capable of creating comparable microenvironments at various operation scales through the continuous introduction and mixing of nanoparticle precursor solutions for the manufacturing of a dispersion comprising nanoparticles, the device including
a first tube having an inlet for a controlled flow of a first nanoparticle precursor solution,
at least a second tube, coaxially arranged within the first tube and having an inlet for a controlled flow of a second nanoparticle precursor solution, and
a mixing portion,
wherein
the first and second tubes have each an outlet which, in conjunction with fluid path elements, generate conditions for the continuous mixing of the nanoparticle precursor solutions and formation of nanoparticles,
and wherein
the fluid path elements include, arranged in the mixing portion, a disrupting physical element designed to cause formation of the microenvironments.

2. Device of claim 1, wherein the disrupting physical element includes a helical groove along the longitudinal axis formed on the surface of one or both tubes, enabling scaling by controlling mixing within the microenvironment through changing flowrates, design, orientation and dimensions of both the pitch and depth of the grooves.

3. Device of claim 1, wherein the disrupting physical element forms an annular outlet from the inner tube that generates the microenvironment, enabling scaling by controlling mixing within the microenvironment through changing the design, dimensions of the annular gap at the point of fluid introduction, flowrates and orientation of the obstruction.

4. Device of claim 1, wherein the first and second tubes have a rectangular cross-section, with an aspect ratio unequal to one, over at least a portion extending from the respective outlet of the first and second tubes to a transition area between the microenvironment mixing portion and a physical disruption, enabling scaling by changing discharge dimensions, orientation, flowrates, and downstream placement of a disrupting physical element.

5. Device of claim 2, wherein the helical groove has a constant pitch along the longitudinal axis.

6. Device of claim 2, wherein the helical groove has a variable pitch along the longitudinal axis.

7. Device of claim 1, wherein the disrupting physical element includes a packed bed of disrupting elements arranged within the mixing portion and defining therebetween interstitial spaces for the combined flow, enabling scaling by changing the design, flowrates, orientation, and dimensions of the bed packing elements, piping, and housing.

8. Device of claim 1, wherein the disrupting physical element includes a coaxially positioned deflector at the outlet of the second tube and defining a gap therewith, said deflector being designed to outwardly deviate the flow from the second tube in an angled direction with respect to the longitudinal axis.

9. Device of claim 8, wherein the device includes a set of further coaxial tubes arranged within the second tube, each further coaxial tube having an outlet and a corresponding coaxially positioned deflector part at the outlet thereof and defining a gap with the associated outer tube, said deflector part being designed to outwardly deviate the flow from the corresponding tube in an angled direction with respect to the longitudinal axis.

10. Device of claim 1, wherein the disrupting physical element includes a longitudinal obturator obstructing the outlet of the second tube and circumferentially distributed radial openings formed in the second tube in the vicinity of the outlet thereof, whereby the flow from the second tube is radially deviated into the mixing portion.

11. Equipment for the manufacturing of a dispersion comprising nanoparticles including an encapsulated payload, comprising
a coaxial flow device according to any one of claims 1 to 10,
a nanoparticle precursor solution connected to the inlet of the first, second, or more tube(s) of the device for the supply of nanoparticle precursor solution to said device, and
a payload solution connected to the inlet of the other tube of the device for the supply of payload solution to said device.
